(19) United States
(12) Patent Application Publication
(10) Pub. No.: US 2026/0330408 A1
(43) Pub. Date: Oct. 22, 2026

(54) SYSTEM

(71) Applicant: SoftBank Group Corp., Tokyo (JP)

(72) Inventor: Minori MATSUNAGA, Tokyo (JP)

(73) Assignee: SoftBank Group Corp., Tokyo (JP)

(21) Appl. No.: 19/649,157

(22) Filed: Apr. 16, 2026

(30) Foreign Application Priority Data
Apr. 22, 2025 (JP) 2025-070701

(51) Int. Cl. G06Q 10/087; G06N 3/042; G06N 3/0464; G06N 3/0475; G06T 19/00; G06V 20/40; G06V 20/52

(52) U.S. Cl. CPC G06Q 10/0877; G06N 3/042; G06N 3/0464; G06N 3/0475; G06Q 10/08726; G06Q 10/08743; G06T 19/006; G06V 20/44; G06V 20/52

(57) ABSTRACT

The present invention relates to an integrated system for a retail business comprising a customer attribute analysis unit, a product display optimization unit, and an integrated inventory management unit in order to realize improvement in consistency of customer experience and operational efficiency in a retail business, wherein each unit integrally analyzes various information such as customer attribute and flow line data acquired from in-store cameras and sensors, inventory and display data by IoT sensors, and inventory and sales data of a physical store and an electronic commerce site using a generative AI, and realizes automatic generation of product information and advertisements optimized for each customer, optimization of product display and replenishment instructions, optimization of inventory allocation based on demand prediction, and further multilingual, tourist, and augmented reality support in real time.

### CROSS-REFERENCE TO RELATED APPLICATION

The present application claims priority to and incorporates by reference the entire contents of Japanese Patent Application No. 2025-070701 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is that in a retail business, it is difficult to provide a consistent customer experience across multiple stores, it takes a great deal of manpower and cost for efficient inventory management and optimization of product display, integration and utilization of customer data between stores are insufficient, flexible adjustment of product display according to seasons and time zones is manual and inefficient, effective product display in a limited space and personalized product recommendation tailored to customer preferences are difficult, differentiation from competitors is difficult and efforts are made to acquire and retain repeat customers, it takes time and cost to improve circulation of the entire facility and optimize a tenant mix, information provision and guidance according to attributes of visitors cannot be performed, flexible space production according to events and seasons is manual and inefficient, and currently, manual inventory management, fixed product display, regular inventory taking, product display based on rules of thumb, regular layout changes, customer management using point cards, regular customer questionnaires, fixed guideboards, seasonal decoration changes, and the like are used as alternative means, but these cannot solve serious management problems such as annual opportunity loss, increase in personnel costs, decrease in new customer acquisition rate and repeat rate, decrease in stay time of visitors, and bias in tenant sales, and an object of the present invention is to comprehensively and efficiently solve these problems using advanced technologies such as generative AI, IoT, edge computing, omnichannel integration, customer behavior analysis, personalized information provision, multilingual support, and augmented reality functions.

### SUMMARY OF THE INVENTION

A means for solving the problem according to the present invention is to provide an integrated system for a retail business comprising a customer attribute analysis unit, a product display optimization unit, and an integrated inventory management unit, wherein the customer attribute analysis unit has a function of analyzing image data and flow line data acquired from cameras and sensors installed in a store in real time by a generative AI, extracting attribute information such as age, gender, facial expression, clothing, belongings, flow line, and stay area of a visiting customer, and dynamically displaying product information and advertisement information optimized for each customer on a display in the store based on the extracted attribute information and flow line information; the product display optimization unit has a function of analyzing various data such as the number of inventory, product take-out history, replenishment history, sales performance for each shelf, weather information, and event information acquired from IoT sensors installed on each product shelf by the generative AI, automatically optimizing a display position and priority of each product according to top-selling products and an inventory status, and issuing a display change instruction to a person in charge or automatically switching display contents of the shelf; the integrated inventory management unit has a function of integrating inventory data of a physical store and an electronic commerce site in real time, predicting future demand by analyzing past sales history, seasonal factors, promotion information, a demand prediction model, and the like by the generative AI, and optimizing inventory allocation to each channel; and the system further realizes low-latency and high-security data processing in each store by an edge computing environment, and integrates multilingual support, tourist information linkage, and an augmented reality function, thereby comprehensively and efficiently solving problems such as inefficiency, opportunity loss, lack of consistency in customer experience, complexity of inventory management, and difficulty in providing personalized information, which have been faced by a conventional retail business.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

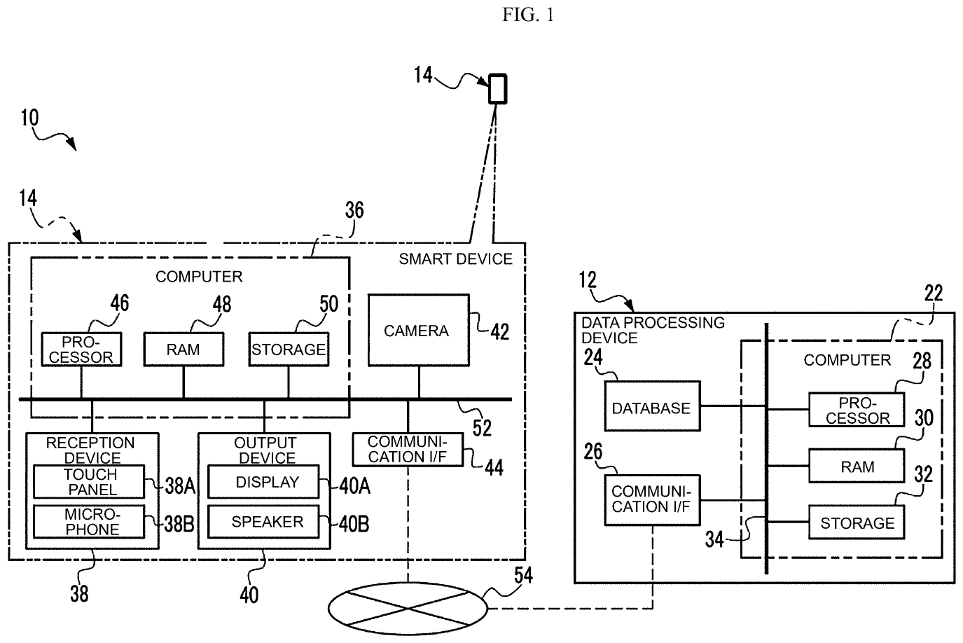

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

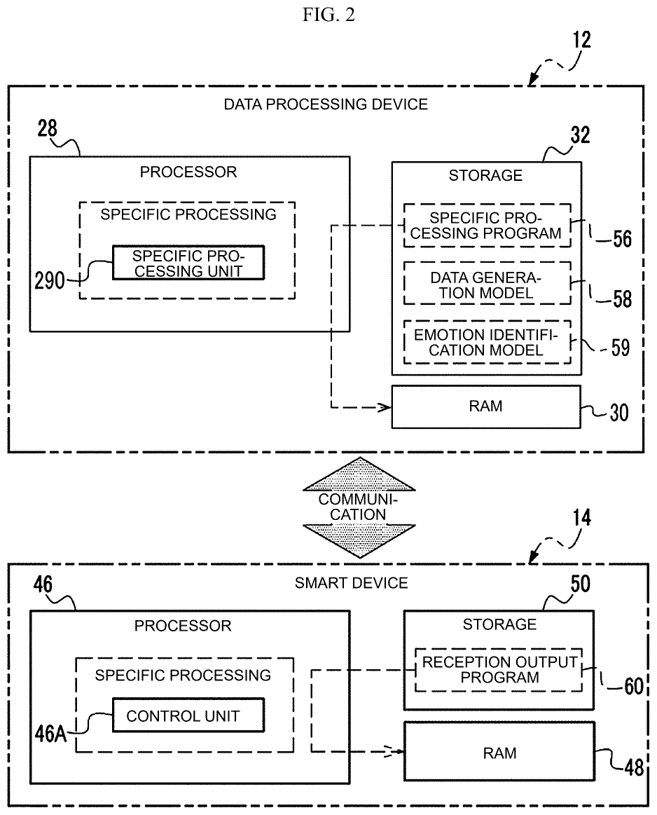

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### EXAMPLE 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. The system of the present invention is composed of a server and terminals (such as an in-store edge terminal, a display terminal, an electronic shelf label, a management tablet, and a smartphone), and functions of each unit are realized with a generative AI as an essential element. Hereinafter, a configuration of each unit, a processing flow, a utilization method of the generative AI, role sharing between the server and the terminals, and specific operation examples will be comprehensively described. Specifically, the present system adopts a distributed computing architecture. The present system dynamically distributes a calculation load between an edge node and a cloud server. The present system cooperatively operates a plurality of neural networks including a large language model and an image generation model. The present system integrally processes multimodal input data in a high-dimensional vector space. Unlike conventional rule-based processing, the present system extracts a latent feature representation from unstructured data using a transformer architecture provided with a self-attention mechanism. Thereby, the present system reduces latency of data processing. The present system suppresses consumption of a network bandwidth. The present system realizes real-time inference processing. The present system brings about technical improvements in specific use cases such as improvement of a customer experience and optimization of inventory management in a retail business.

The customer attribute analysis unit acquires various data such as a face image, a full-body image, a walking speed, a movement route, a stay time, the number of stops, and an action in front of a shelf (such as a hand movement and the number of product contacts) of a visiting customer from cameras (such as an RGB camera, a depth camera, and a thermography camera) and sensors (such as an infrared sensor, a beacon, a Wi-Fi sensor, and a BLE tag) installed at a plurality of locations such as a store entrance, a sales floor, a cash register, an event space, and an aisle. For example, from the face image acquired by the entrance camera, the terminal side performs face detection and blurring processing, performs simple estimation of age and gender, and then transmits an anonymized image and attribute data to the server. The generative AI on the server estimates age (e.g., around 35 years old), gender (e.g., female), facial expression (e.g., smile, surprise, expressionless), clothing (e.g., business suit, casual, sportswear), belongings (e.g., stroller, shopping basket, backpack), and further presence or absence of wearing a mask and presence or absence of wearing a hat from the face image with high accuracy. From the full-body image and the flow line data, the walking speed of the customer (e.g., walking slowly, in a hurry), a circulation pattern (e.g., entrance→fruit and vegetable corner→meat corner→cash register), the stay time (e.g., staying in front of a beverage shelf for 5 minutes), the number of product contacts (e.g., picking up product A three times), and the like are extracted. The generative AI integrates these multidimensional data and automatically generates a detailed profile such as “woman in her 30s, sportswear, using a stroller, staying in the beverage corner for a long time, interested in health-oriented products” for each customer. Specifically, the customer attribute analysis unit executes a convolutional neural network in the edge terminal. The edge terminal extracts a bounding box of a face region from the input RGB image. The edge terminal applies a Gaussian filter to the extracted face region to execute blurring processing. The edge terminal generates an image tensor in a state where privacy is protected. The edge terminal transmits the image tensor to the server. The server inputs the received image tensor to a pre-trained vision transformer model. The vision transformer model divides the input data into patches. The vision transformer model calculates a spatial dependency between the patches using a self-attention mechanism. The vision transformer model outputs a probability distribution vector indicating age and gender. For example, the model outputs a numerical vector indicating that a probability of being around 35 years old is 0.85 as an output of a softmax function for an age class. The model outputs a numerical vector indicating that a probability of being female is 0.92 as a gender class. The model outputs a numerical vector indicating that a probability of a smile is 0.78 as a facial expression class. The server further inputs the flow line data as a time-series array to a recurrent neural network. The recurrent neural network updates a hidden state vector from the time-series array. The recurrent neural network extracts feature amounts of the stay time and the walking speed. The server combines the image feature amount vector and the flow line feature amount vector. The server inputs the combined multidimensional vector to a prompt encoder of a large language model. The large language model generates a customer profile text in natural language from the multidimensional vector. The present system inputs the output profile text to a subsequent recommendation module. The present system calculates an interest level score of the customer in the recommendation module. The present system specifies a product category whose score exceeds a predetermined threshold. Thereby, the present system eliminates judgment by human visual inspection. The present system dramatically improves accuracy of attribute estimation by integrating feature amounts in a high-dimensional space. The present system exhibits an extremely high technical effect in a use case of automating personalized marketing measures. The present system uses a cross-entropy error function in learning of the model. The present system optimizes weights of the network by a gradient descent method. The present system applies random cropping and color tone conversion of an image as a data augmentation method. Thereby, the present system improves generalization performance of the model.

Based on this profile, the generative AI generates optimal product information and advertisement information for each customer using a natural language generation model and an image generation model. For example, the generative AI automatically generates a personalized advertisement text such as “How about a low-carbohydrate sports drink that arrived today?” or “Here is a new snack corner for children,” and further generates a usage scene and an image image of the product (e.g., a state of enjoying a picnic with a family, an image of a woman refreshing after sports). These pieces of information are distributed in real time to a display terminal (such as a large signage, an on-shelf display, and a tablet next to a cash register) in the store. For example, when the customer approaches the beverage corner, the display automatically displays “this week's recommended health beverage,” “new product to enjoy with children,” and the like, and contents are immediately switched according to the attribute and the flow line of the customer. Furthermore, the generative AI also analyzes a reaction of the customer (e.g., stopping in front of the display, reading a QR code with a smartphone for the display contents, etc.) in real time, and continuously optimizes contents of the advertisement and the product proposal. Specifically, the server inputs the generated customer profile text to the large language model. The large language model autoregressively generates an advertisement text in natural language using a decoder block of the transformer architecture. The large language model applies the self-attention mechanism to a word embedding vector of the input profile text. The large language model outputs a probability distribution of an optimal word according to a context. For example, the large language model outputs a text string “How about a low-carbohydrate sports drink that arrived today?”. The large language model outputs a text string “Here is a new snack corner for children”. The server further inputs the generated advertisement text to a latent diffusion model. The latent diffusion model executes a text-conditioned denoising process. The latent diffusion model gradually generates a meaningful image tensor from random Gaussian noise. For example, the latent diffusion model outputs an RGB image tensor of a state of enjoying a picnic with a family. The latent diffusion model outputs an RGB image tensor of a woman refreshing after sports. The server integrates the generated text string and the image tensor. The server transmits the integrated multimedia data to the display terminal in the store via a network. The display terminal expands the received data in a video memory. The display terminal draws advertisement contents on a screen. The present system further acquires a line-of-sight vector and the stay time of the customer from a camera built in the display terminal. The present system inputs these reaction data as a reward signal to a reinforcement learning algorithm. The present system dynamically updates parameters of an advertisement generation model using a proximal policy optimization method. Thereby, the present system realizes adaptive content generation according to the reaction of the customer. The present system executes an unconventional processing procedure different from conventional fixed advertisement display. The present system brings about a technical effect of improving a click rate and a purchase conversion rate of the advertisement. The present system is extremely useful in a use case of dynamic advertisement distribution using digital signage.

The product display optimization unit acquires the number of inventory, a product take-out/replenishment history, sales performance for each shelf, a turnover rate for each product, a customer stay time in front of a shelf, the number of product contacts, and the like from IoT sensors (such as a weight sensor, an RFID reader, an infrared sensor, and a camera) installed on each product shelf. For example, the weight sensor detects that product A has decreased from 10 to 7, and the RFID reader grasps that product B has been replenished. These data are primarily aggregated by an in-store terminal and transmitted to the server. The generative AI on the server integrally analyzes various external data such as inventory data, sales performance, weather information (e.g., an increase in demand for umbrellas and raincoats in rainy weather), event information (e.g., an increase in demand for sports drinks and light meals when a sports tournament is held nearby), past sales transition, sales trends of neighboring stores, and SNS trend information. For example, when a product talked about on SNS starts to sell rapidly, the generative AI generates an instruction to move the product to a conspicuous shelf position. A specific display change instruction and replenishment instruction such as “move product A to the center of the shelf,” “place product B at eye level,” and “recommend replenishing product C because only a few are left” are notified to a person in charge through a management tablet or a smartphone terminal. In cooperation with an electronic shelf label and digital signage, a product price, a promotional text, an inventory status, the remaining number, limited sale information, and the like are also automatically switched. For example, the generative AI automatically generates a promotional text such as “special price only now,” “3 left,” and “product talked about on SNS” and displays the promotional text on the electronic shelf label. Furthermore, when the number of times the customer picks up the product in front of the shelf or the stay time is long, the generative AI determines that the degree of interest in the product is high, and displays a cross-sell proposal of a related product (e.g., “those who purchased this product also purchased this”) on the display or the shelf label. Specifically, the product display optimization unit acquires a time-series sensor data array from an IoT sensor group. The product display optimization unit converts an analog voltage value from the weight sensor into a digital numerical value by an AD converter. The product display optimization unit demodulates a radio signal from the RFID reader to extract a product identification code. The in-store terminal buffers these digital numerical values and the product identification code together with a time stamp as structured data in a memory. The in-store terminal transmits the buffered structured data to the server at a predetermined cycle. The server inputs the received structured data to a graph neural network. The graph neural network holds a graph structure expressing a physical arrangement of product shelves by nodes and edges. The graph neural network assigns numerical values of the number of inventory and the sales performance as a feature amount vector of each node. The graph neural network aggregates the feature amount vector between adjacent nodes by message passing. The graph neural network outputs a score indicating sales efficiency of the entire shelf. The server further vectorizes the weather information and the SNS trend information as external data by a natural language processing model. The server combines the output score of the graph neural network and the external data vector. The server inputs the combined vector to a multilayer perceptron. The multilayer perceptron outputs coordinate data of an optimal display position of each product. For example, the multilayer perceptron outputs instruction data to move product A to coordinates XY of the shelf. The multilayer perceptron outputs instruction data to place product B at coordinates ZW. The server push-notifies this instruction data to the management tablet. The server simultaneously generates a display update command for the electronic shelf label. The server rewrites an electronic paper display of the electronic shelf label via a wireless communication interface. The present system executes an anomaly detection algorithm using the stay time and the number of product contacts of the customer as input feature amounts. The present system sets a flag for a cross-sell proposal when the interest level score exceeds a threshold. The present system searches a database for an identification code of a related product based on the flag. The present system displays a search result on the display. Thereby, the present system dynamically links physical product arrangement and digital information presentation. The present system realizes data-driven display optimization that does not depend on human rules of thumb. The present system brings about technical effects of maximizing sales and preventing out-of-stock. The present system is applied to a use case of automating store operation in smart retail.

The integrated inventory management unit integrally manages inventory data of a physical store (such as the number of inventory for each shelf, a replenishment history, and a return history) and inventory data of an electronic commerce site (such as warehouse inventory, a shipping history, and a return history) in real time. For example, when there are 10 products A in the physical store and 5 products A in the electronic commerce site warehouse, both inventories are added up and grasped unitarily. These data are aggregated from each store terminal and a server of the electronic commerce site to the integrated inventory management unit on the server. The generative AI analyzes various data such as a past sales history (e.g., sales transition by day of the week, by time zone, by season, and by event), seasonal factors (e.g., an increase in demand for cold beverages in summer and warm food in winter), weather information (e.g., an increase in demand for umbrellas and raincoats in rainy weather), promotion information (e.g., an increase in sales during a double point campaign), event information (e.g., an increase in demand for souvenirs when a local festival is held), and regional characteristics (e.g., souvenirs and region-limited products are easy to sell in tourist spots), and predicts future demand with high accuracy. For example, the generative AI predicts that “demand for product A will increase by 30% because the temperature will be high next week,” and automatically optimizes inventory allocation to the physical store and the electronic commerce site. Furthermore, in order to prevent out-of-stock and overstock, an inventory movement instruction between stores and between channels (e.g., inventory movement from the physical store to the electronic commerce site warehouse, and conversely replenishment from the EC warehouse to the store) and a replenishment instruction (e.g., automatic ordering from a headquarters warehouse to each store) are automatically generated and notified to a management terminal. Demand prediction and an inventory allocation result are automatically generated by the generative AI as visualization data such as a graph, a heat map, and a time-series chart, and displayed on a management screen. For example, a specific action plan such as “allocate 10 products A to each store because demand for 20 products A is predicted next week” and “recommend strengthening promotion for product B due to overstock” is also automatically presented. Specifically, the integrated inventory management unit synchronizes an inventory database of the physical store and an inventory database of the electronic commerce site by distributed transaction processing. The integrated inventory management unit combines records of both databases to generate a unitary inventory tensor. The server inputs multidimensional time-series data such as the past sales history and the weather information to a long short-term memory network. The long short-term memory network learns a long-term dependency of the time-series data. The long short-term memory network updates a cell state using a forget gate and an input gate. The long short-term memory network outputs an array of demand prediction values at a plurality of future time steps. For example, the long short-term memory network outputs a numerical value of 30 as a demand prediction value of product A for next week. The long short-term memory network outputs a numerical value of 5 as a demand prediction value of product B. The server inputs the output array of demand prediction values to a linear programming solver. The linear programming solver minimizes a transportation cost and a storage cost as an objective function. The linear programming solver outputs a matrix of an optimal inventory allocation amount to each store and warehouse. For example, the linear programming solver outputs numerical data to allocate 10 inventories to the physical store. The linear programming solver outputs numerical data to allocate 20 inventories to the electronic commerce site warehouse. The server generates a control command for the inventory movement instruction based on this allocation amount matrix. The server transmits the control command to the management terminal of each base. The server further inputs data of the demand prediction value and the inventory allocation amount to a visualization module. The visualization module converts numerical data into pixel values to generate an image tensor of a heat map. The visualization module plots time-series data to generate an image tensor of a chart. The server renders the generated image tensor on a screen of an administrator interface. The present system further generates an action plan in natural language from numerical data using the large language model. For example, the present system outputs a text that 10 products A are allocated to each store because demand for 20 products A is predicted next week. Thereby, the present system solves a complex supply chain optimization problem at high speed using computing power of a computer. The present system brings about technical effects of reducing overstock and preventing opportunity loss due to shortage. The present system is extremely effective in a use case of automating inventory management in an omnichannel retail business. The present system uses a mean square error as a loss function in learning of the model. The present system optimizes weights of the network by an error backpropagation method.

The system of the present invention utilizes an edge computing environment, performs primary data processing and preprocessing (e.g., face blurring of an image, anonymization of personal information, simple attribute estimation, filtering of sensor data, etc.) in each store terminal, and transmits only anonymized and aggregated data to the server, thereby achieving both privacy protection and real-time performance. For example, raw data of a face image is immediately deleted in the store terminal, and only attribute data is transmitted to the server. As a multilingual support function, the generative AI determines a language attribute (e.g., Japanese, English, Chinese, Korean, etc.) of the customer, and automatically generates product information and advertisement information in multiple languages. For example, when a foreign tourist visits the store, a product description and tourist guidance are displayed on the display in English or Chinese, and multilingual voice guidance is further provided using voice synthesis technology. As a tourist information linkage function, the generative AI automatically collects and summarizes local tourist spots, event information, traffic information, weather information, and the like, and provides optimal information according to the customer attribute and the flow line. For example, when a tourist is staying in a souvenir corner, “here are nearby tourist attractions,” “local event information held today,” and the like are displayed. As an augmented reality function, when the customer holds a smartphone or a tablet over a product shelf, the generative AI generates detailed product information, a usage scene video, a promotion video, a 3D model, and the like in real time, and superimposes and displays them on a terminal screen. For example, when the smartphone is held over a cosmetics corner, the generative AI generates a recommended product and a usage video tailored to a skin type and a season, and displays them on the screen. In a furniture sales floor, it is also possible to display an image of arranging furniture in a room of a home with a 3D model. Specifically, the present system adopts an edge computing architecture. The store terminal locally executes an image processing algorithm by a parallel computing cluster using a built-in GPU. The store terminal applies a cascade classifier for face detection to the input raw image tensor. The store terminal encrypts pixel values of the detected face region with an irreversible hash function. The store terminal completely erases the raw image tensor from a volatile memory. The store terminal transmits only the encrypted attribute vector to the server by a secure communication protocol. Thereby, the present system dramatically reduces consumption of a network bandwidth. The present system minimizes latency of data transfer. The present system ensures an extremely high security level from a viewpoint of privacy protection. The server inputs the received attribute vector to a multilingual support module. The multilingual support module converts waveform data of an utterance voice of the customer into text using a voice recognition model. The multilingual support module outputs a language label of the text using a language identification classifier. For example, the classifier outputs a label of Chinese. The classifier outputs a label of English. The server switches weights of a machine translation model based on the language label. The machine translation model converts text of product information into text of a target language. The server further generates voice waveform data from the translated text using a text-to-speech synthesis model. The server outputs the voice waveform data from a speaker of the store. The server executes a web scraping bot as a tourist information linkage function. The bot acquires latitude and longitude data of a tourist spot and structured data of an event holding date and time from an external API. The server inputs the structured data to the large language model to generate a summary text. The server acquires a posture matrix of a camera and plane detection data from the smartphone of the customer as an augmented reality function. The server projectively transforms 3D polygon mesh data of the product into a screen coordinate system of the smartphone. The server renders the 3D model superimposed on an actual camera video using the GPU of the smartphone. Thereby, the present system seamlessly integrates a real space and a virtual space. The present system brings about a technical effect of providing an immersive purchasing experience to the customer. The present system creates innovative value in use cases such as inbound support and virtual fitting.

Furthermore, the generative AI also analyzes a purchase history, point card information, SNS account linkage information, and the like of the customer, and automatically generates a special offer and a coupon for a repeat customer, a birthday privilege, a related product proposal with a past purchased product, and the like. For example, a personalized message such as “a new product suitable for product A purchased last time has arrived” and “happy birthday, presenting a coupon limited to today” is generated and distributed to an application, an email, and a display terminal. At the time of an event, the generative AI automatically generates an event guidance text, a participation promotion message, limited novelty information, and the like according to the attribute and the flow line of the visiting customer, and distributes them to various terminals inside and outside the store. For example, event information is optimized in real time, such as “workshop for children held from 14:00 today” and “limited goods present to the first 100 people”. Specifically, the server extracts an identification code array of past purchased products from a purchase history database of the customer. The server extracts numerical values of the cumulative number of points and a visit frequency from the point card information. The server extracts a posted text of the customer and a history of likes from the SNS account linkage information. The server inputs these heterogeneous data to a natural language processing model to generate a high-dimensional embedding vector representing a preference of the customer. The server inputs this embedding vector to the large language model as a part of a prompt. The large language model generates a text string of a personalized message matching the preference of the customer. For example, the large language model outputs a text that a new product suitable for product A purchased last time has arrived. The large language model outputs a text of happy birthday, presenting a coupon limited to today. The server transfers the generated text string to a push notification server. The push notification server transmits a message to a smartphone application of the customer by asynchronous communication. The server further inputs a real-time congestion degree score and a flow line vector acquired from a camera and a sensor in the store to an event optimization module. The event optimization module determines parameters of an event guidance text optimal for a current store situation using a reinforcement learning agent. The server inputs the determined parameters to the large language model. The large language model outputs a text that a workshop for children is held from 14:00 today. The large language model outputs a text of a limited goods present to the first 100 people. The server immediately distributes the generated text to digital signage and an electronic shelf label in the store. Thereby, the present system breaks away from a static rule-based marketing method. The present system realizes automatic generation of dynamic and adaptive promotion. The present system brings about technical effects of improving customer engagement and promoting store visits. The present system shows extremely high usefulness in use cases such as construction of a retail media network and dynamic pricing.

As described above, the embodiment of the present invention comprehensively realizes extremely multifaceted and specific functions such as advanced information analysis and generation by the generative AI on the server, real-time data acquisition and preprocessing by the store terminal, linkage of various devices such as IoT sensors and cameras, information distribution to various output devices such as a display terminal, an electronic shelf label, and a smartphone, low-latency and high-security operation by edge computing, multilingual, tourist, and augmented reality support, personalized information provision, cross-channel inventory optimization, and event and promotion automation, and comprehensively and efficiently solves problems that have been difficult to realize by conventional technology, such as improvement of consistency of a customer experience in a retail business site, efficiency improvement of inventory management and product display, sophistication of management judgment, regional revitalization support, repeat customer acquisition promotion, opportunity loss minimization, and work load reduction. Specifically, the present system integrates a plurality of neural network models on a microservice architecture. The present system optimizes data communication between an edge device and a cloud server using an asynchronous messaging queue. The present system processes a huge amount of stream data from an IoT sensor group at high speed with an in-memory database. The present system executes hardware acceleration utilizing a tensor core in inference processing of the large language model. Thereby, the present system maximizes utilization efficiency of computing resources. The present system shortens processing latency of the entire system to a millisecond unit. The present system completely eliminates a conventional mental process of manual data analysis and content creation by a human. The present system brings about an improvement in computer technology itself. The present system extracts a latent need of the customer with high accuracy by feature amount calculation in a high-dimensional vector space. The present system realizes optimization of an entire supply chain by real-time synchronization of inventory data across channels. The present system provides an intuitive user interface using augmented reality technology. The present system exhibits an effect of improving consistency of a customer experience in a retail business by a combination of these technical means. The present system exhibits an effect of improving efficiency of inventory management and product display. The present system exhibits an effect of sophisticating management judgment. The present system exhibits an effect of supporting regional revitalization. The present system exhibits an effect of promoting repeat customer acquisition. The present system exhibits an effect of minimizing opportunity loss. The present system exhibits an effect of reducing a work load. The present system provides an essential base technology in next-generation use cases such as full automation of a smart store and operation of an unmanned store. The present system constructs a continuous learning pipeline of a model. The present system periodically fine-tunes weights of a neural network using new data accumulated daily. Thereby, the present system maintains high adaptability to environmental changes.

### (System Configuration)

The system according to the present embodiment includes a customer attribute analysis unit, a product display optimization unit, an integrated inventory management unit, an information output unit, a data collection unit, a generative AI linkage unit, and an administrator interface unit. The customer attribute analysis unit receives various data such as a face image, a full-body image, a walking speed, a movement route, a stay time, the number of stops, an action in front of a shelf, and the number of product contacts of a visiting customer acquired from an RGB camera, a depth camera, a thermography camera, an infrared sensor, a beacon, a Wi-Fi sensor, a BLE tag, and the like installed at a plurality of locations such as a store entrance, a sales floor, a cash register, an event space, and an aisle, primarily preprocesses these data in an in-store edge terminal, performs face detection and blurring processing, simple estimation of age and gender, and anonymization of personal information, and then transmits the data to a server. A generative AI on the server estimates age, gender, facial expression, clothing, belongings, presence or absence of wearing a mask and a hat, and the like from the face image with high accuracy, extracts the walking speed, a circulation pattern, the stay time, the number of product contacts, and the like from the full-body image and flow line data, and generates a detailed profile for each customer. For example, a profile such as a woman in her 30s, sportswear, using a stroller, staying in a beverage corner for a long time, and interested in health-oriented products is automatically generated. Furthermore, a purchase history, point card information, SNS account linkage information, and the like of the customer are also analyzed, and a special offer and a coupon for a repeat customer, a birthday privilege, a related product proposal with a past purchased product, and the like are automatically generated. For example, a personalized message such as “a new product suitable for product A purchased last time has arrived” and “happy birthday, presenting a coupon limited to today” is generated and distributed to an application, an email, and a display terminal. Specifically, the present system connects each hardware component by a high-speed internal bus and a broadband network. The customer attribute analysis unit executes a lightweight convolutional neural network expanded on a memory of the edge terminal. The edge terminal performs segmentation processing in pixel units on an image tensor acquired from the RGB camera. The edge terminal extracts a silhouette region of a person. The edge terminal calculates three-dimensional coordinates of the person using a distance data matrix acquired from the depth camera. The edge terminal measures a body surface temperature using a temperature distribution matrix acquired from the thermography camera. The edge terminal integrates these multimodal data to generate a feature amount vector. The edge terminal hashes pixel data of a face region by an irreversible compression algorithm. The edge terminal generates an anonymized vector that cannot identify an individual. The edge terminal transmits the anonymized vector to the server. The server inputs the received anonymized vector to a pre-trained multilayer perceptron. The multilayer perceptron outputs a probability distribution vector of an age class. The multilayer perceptron outputs a probability distribution vector of a gender class. The multilayer perceptron outputs a probability distribution vector of a facial expression class. The server further inputs a hash value of a MAC address and a time-series array of a received signal strength indicator acquired from the beacon and the Wi-Fi sensor to a Kalman filter. The Kalman filter removes noise and outputs a coordinate array of a smoothed movement trajectory. The server calculates scalar values of the walking speed and the stay time from the coordinate array. The server combines these scalar values and the probability distribution vector of the attribute. The server inputs the combined vector to a large language model. The large language model generates a profile text such as a woman in her 30s, sportswear, using a stroller, staying in a beverage corner for a long time, and interested in health-oriented products. The server further vectorizes time-series data of a purchase amount extracted from a purchase history database and text data of SNS by a natural language processing model. The server inputs these vectors to the large language model as a prompt. The large language model outputs a text that a new product suitable for product A purchased last time has arrived. The large language model outputs a text of happy birthday, presenting a coupon limited to today. Thereby, the present system realizes objective and highly accurate customer analysis excluding human subjectivity. The present system brings about a technical effect of automating personalized information distribution. The present system is applied to a use case of sophisticating a customer relationship management system.

The product display optimization unit acquires the number of inventory, a product take-out/replenishment history, sales performance for each shelf, a turnover rate for each product, a customer stay time in front of a shelf, the number of product contacts, and the like from a weight sensor, an RFID reader, an infrared sensor, a camera, and the like installed on each product shelf, primarily aggregates them in an in-store terminal, and then transmits them to a server. A generative AI on the server integrally analyzes various external data such as inventory data, sales performance, weather information, event information, past sales transition, sales trends of neighboring stores, and SNS trend information, and automatically optimizes a display position and priority of each product according to top-selling products and an inventory status. For example, when a product talked about on SNS starts to sell rapidly, the generative AI generates an instruction to move the product to a conspicuous shelf position. A person in charge is notified of a specific display change instruction and replenishment instruction such as “move product A to the center of the shelf,” “place product B at eye level,” and “replenishment is recommended because product C is running low” through a management tablet or a smartphone terminal. In cooperation with an electronic shelf label and digital signage, a product price, a sales promotion text, an inventory status, the number of remaining items, limited sale information, and the like are also automatically switched. For example, the generative AI automatically generates a sales promotion text such as “special price only for now,” “3 items remaining,” and “product talked about on SNS,” and displays it on the electronic shelf label. Furthermore, when the number of times a customer picks up a product in front of a shelf or a stay time is long, it is determined that the degree of interest in the product is high, and a cross-sell proposal for a related product is displayed on a display or a shelf label. Specifically, the product display optimization unit collects sensor data via a microcontroller and a communication module incorporated in each product shelf. The microcontroller amplifies a minute voltage change obtained from a strain gauge of the weight sensor by an amplifier circuit. The microcontroller converts the amplified analog signal into a digital value to generate scalar data of the number of inventory. The microcontroller detects a hand movement of a customer from a light-shielding pattern of the infrared sensor and increments a count value of the number of product contacts. The in-store terminal accumulates the scalar data and the count value as log data with a time stamp in a local storage. The in-store terminal transmits the log data to the server by batch processing. The server stores the received log data in a time-series database. The server inputs an array of the inventory data and the sales performance extracted from the time-series database to a gradient boosting decision tree algorithm. The algorithm calculates a sales prediction score of each product. The server further inputs numerical data of a precipitation probability acquired from an API of weather information and an appearance frequency vector of a trend word acquired from an API of SNS to a natural language processing model. The server extracts feature amounts of these external data. The server combines the sales prediction score and the feature amounts of the external data. The server inputs the combined data as an environmental state vector of a reinforcement learning agent. The reinforcement learning agent updates an action value function with sales maximization as a reward function. The reinforcement learning agent outputs optimal display coordinates of each product. The server generates a text command to move product A to the center of the shelf based on the display coordinates. The server generates a text command to place product B at eye level. The server generates a text command that replenishment is recommended because product C is running low. The server transmits these commands to an application interface of the management tablet. The server simultaneously transmits a display update payload to a gateway of the electronic shelf label by a wireless communication protocol. The server generates a text “special price only for now” using a large language model. The server generates a text “3 items remaining”. The server generates a text “product talked about on SNS”. The server writes these texts into a memory of the electronic shelf label. The system executes a collaborative filtering algorithm when the stay time of the customer exceeds a predetermined threshold. The system outputs an identifier of a related product. The system displays product information corresponding to the identifier on the display. The system thereby realizes dynamic reconfiguration of a physical store space. The system brings about technical effects of improving efficiency of display work and improving sales. The system is extremely effective in a use case of data-driven store layout optimization.

The integrated inventory management unit integrally manages inventory data of a physical store (such as the number of inventory for each shelf, a replenishment history, and a return history) and inventory data of an electronic commerce site (such as warehouse inventory, a shipping history, and a return history) in real time, and a generative AI on a server analyzes various data such as a past sales history, seasonal factors, weather information, promotion information, event information, and regional characteristics to predict future demand with high accuracy. For example, the generative AI predicts an increase in demand for cold beverages in summer, an increase in demand for warm food in winter, an increase in demand for umbrellas and raincoats in rainy weather, an increase in demand for souvenirs when a local festival is held, and the like, and automatically optimizes inventory allocation to the physical store and the electronic commerce site. Furthermore, in order to prevent out-of-stock and overstock, the generative AI automatically generates an inventory movement instruction and a replenishment instruction between stores and between channels, and notifies a management terminal of the inventory movement instruction and the replenishment instruction. A demand prediction result and an inventory allocation result are automatically generated by the generative AI as visualization data such as a graph, a heat map, and a time-series chart, and are displayed on a management screen. For example, a specific action plan such as “allocate 10 items to each store because a demand of 20 items is predicted for product A next week” and “recommend strengthening promotion because product B is overstock” is also automatically presented. Specifically, the integrated inventory management unit synchronizes inventory records of the physical store and the electronic commerce site in real time using a distributed database management system. The integrated inventory management unit generates a multidimensional inventory vector having the number of inventory at each base as an element. The server converts time-series data of the past sales history and categorical data of the seasonal factors into a numerical vector by one-hot encoding. The server combines numerical data of the weather information and flag data of the promotion information to construct an input feature amount tensor. The server inputs the input feature amount tensor to a transformer-based time-series prediction model equipped with a self-attention mechanism. The time-series prediction model learns a complex correlation between past data points. The time-series prediction model outputs a probability distribution of a demand amount at each future time step. For example, the time-series prediction model learns a pattern that demand for cold beverages increases in summer. The time-series prediction model learns a pattern that demand for warm food increases in winter. The time-series prediction model learns a pattern that demand for umbrellas and raincoats increases in rainy weather. The time-series prediction model learns a pattern that demand for souvenirs increases when a local festival is held. The server calculates an expected value of the output demand amount to generate an array of demand prediction values. The server inputs the array of the demand prediction values and the current inventory vector to a constrained optimization solver. The solver evaluates an objective function that minimizes a sum of a transportation cost and a storage cost. The solver outputs a matrix of an optimal inventory movement amount between the respective bases. The server generates transaction data of the inventory movement instruction based on this matrix. The server transmits the transaction data to the management terminal. The server further inputs data of the demand prediction value and the inventory allocation amount to a data visualization engine. The engine maps numerical data to a pixel value in a color space to generate an image tensor of a heat map. The engine maps time-series data to a coordinate space to generate an image tensor of a time-series chart. The server writes the generated image tensor into a frame buffer of the management screen. The server generates a natural language text from numerical data using a large language model. For example, the large language model outputs a text “allocate 10 items to each store because a demand of 20 items is predicted for product A next week”. The large language model outputs a text “recommend strengthening promotion because product B is overstock”. The system thereby eliminates uneven distribution of inventory in the entire supply chain. The system brings about technical effects of reducing a logistics cost and improving a cash flow. The system is applied to a use case of integrated inventory management in omnichannel retailing.

The information output unit distributes product information, advertisement information, a sales promotion text, an image, a video, a coupon, an event guide, tourist information, augmented reality contents, and the like generated by a generative AI to various output devices such as an in-store display terminal, an electronic shelf label, a smartphone, a tablet, a terminal next to a cash register, an application, and an email in real time. For example, when a customer approaches a beverage corner, a display automatically displays “this week's recommended health beverage,” “new product to enjoy with children,” and the like, and contents are immediately switched according to an attribute and a flow line of the customer. When a smartphone or a tablet is held over a product shelf, the generative AI generates detailed product information, a usage scene video, a promotion video, a 3D model, and the like in real time, and superimposes and displays them on a terminal screen. For example, when a smartphone is held over a cosmetics corner, a recommended product and a usage video suitable for a skin type and a season are generated and displayed on a screen. In a furniture sales floor, it is also possible to display an image of furniture arranged in a room of a home with a 3D model. Specifically, the information output unit includes a communication interface that receives multimedia data transmitted from a server via a network. The information output unit includes a graphics processing unit that decodes the received data and expands it in a video memory. The server generates a text character string of a personalized sales promotion text from an attribute vector of a customer using a large language model. The server generates a high-resolution image tensor and a frame array of a video from the text character string using a latent diffusion model. The server streams and distributes the generated contents to an in-store display terminal and an electronic shelf label. For example, the system detects that a flow line vector of a customer has approached coordinates of a beverage corner. The system immediately switches a display buffer of the display terminal. The system draws a text “this week's recommended health beverage”. The system draws a text “new product to enjoy with children”. The system dynamically changes a pointer of display contents according to an attribute cluster of the customer. The system further receives a video stream of a camera transmitted from a smartphone of the customer. The system applies a feature point extraction algorithm to each frame of the video stream. The system calculates a plane equation of a product shelf. The system performs perspective projection transformation of 3D polygon mesh data of a product generated on the server into a screen coordinate system of the smartphone. The system calls a graphics API of the smartphone to superimpose and draw the 3D model on a real video by alpha blending. For example, the system generates a 3D model of a personalized recommended product with a skin type parameter of a customer as an input in a cosmetics corner. The system maps a texture of a usage video to a polygon and displays it on a screen. The system generates a rendering image in which a 3D model of furniture is arranged in point cloud data of a room of a home in a furniture sales floor. The system thereby seamlessly fuses digital contents and a physical space. The system brings about a technical effect of stimulating a customer's willingness to buy. The system provides extremely high value in a use case of an interactive shopping experience using augmented reality.

The data collection unit collects customer attribute data, flow line data, inventory data, sales performance data, external environment data, promotion information, event information, SNS trend information, and the like from various data sources such as a camera, a sensor, an IoT device, a POS system, an electronic commerce site, SNS, a weather information API, and a regional event information API in real time, primarily processes them in an in-store terminal, and then aggregates them in a server. For example, a sales history for each product is acquired from the POS system, an order history and an inventory status are acquired from the electronic commerce site, a talked-about product and a trend word are acquired from SNS, a temperature and a precipitation probability are acquired from the weather information API, and information on an event scheduled to be held is acquired from the regional event information API. Specifically, the data collection unit acquires data in parallel from various data sources using a plurality of asynchronous IO threads. The data collection unit continuously reads an RGB image tensor from a camera into a memory buffer according to a frame rate. The data collection unit receives a payload of sensor data from an IoT device via an MQTT protocol. The data collection unit extracts structured data of a sales transaction from a POS system by an SQL query. The data collection unit acquires a record of an order history and an inventory status from a database of an electronic commerce site via a RESTful API. The data collection unit connects to a public stream API of SNS to acquire posted data in a JSON format. The data collection unit acquires numerical data of a temperature and a precipitation probability at a designated latitude and longitude from a weather information API. The data collection unit acquires text data of a holding date and time and a place of an event from a regional event information API. The in-store terminal executes a data cleansing process of converting these data of heterogeneous formats into structured data having a common schema. The in-store terminal applies a filtering algorithm that interpolates a missing value and removes an abnormal value. The in-store terminal encodes the preprocessed data with a compression algorithm. The in-store terminal transmits the encoded data to a server via a secure virtual private network tunnel. The server stores the received data in a data lake on a distributed file system. For example, the server acquires a time-series array of a sales quantity and a sales amount for each product from a POS system. The server acquires a character string array of a talked-about product name and a trend word from SNS. The system thereby unitarily integrates various siloed data. The system brings about a technical effect of providing high-quality learning data and inference data to a subsequent machine learning model. The system realizes an indispensable data pipeline in a use case of constructing a big data analysis infrastructure.

The generative AI linkage unit links a generative AI operating on a server with each unit to realize advanced information processing such as customer attribute analysis, flow line analysis, demand prediction, inventory allocation optimization, natural language generation, image generation, video generation, multilingual translation, tourist information summarization, and augmented reality content generation. For example, based on a customer profile, a prompt text such as “generate an advertisement text and a usage scene image of a low-carbohydrate sports drink for a customer who is a woman in her 30s, wears sportswear, uses a stroller, and is interested in health-oriented products” is input to the generative AI. For product display optimization, a prompt text such as “generate a display plan to move product A talked about on SNS this week to the center of the shelf and place product B at eye level” is used. In integrated inventory management, a prompt text such as “generate a demand prediction of product A for next week and an optimal store/EC inventory allocation plan in consideration of a sales history for the past three months, weather information, and event information” is used. In multilingual support, a prompt text such as “generate a recommended product description text of a souvenir corner for a tourist speaking Chinese” is input to the generative AI. In augmented reality content generation, a prompt text such as “generate a 3D model in which product A in a furniture sales floor is arranged in a living room of a home, and also create a usage scene video” is used. Specifically, the generative AI linkage unit manages an inference engine of a large language model and an image generation model expanded on a main memory of a server. The generative AI linkage unit includes a template engine that converts structured data and a numerical vector received from each module into a prompt character string of a natural language. The generative AI linkage unit inputs the prompt character string to a tokenizer to convert it into an array of token IDs. The generative AI linkage unit supplies the array of token IDs to an input layer of the large language model. For example, the generative AI linkage unit constructs a prompt character string “generate an advertisement text and a usage scene image of a low-carbohydrate sports drink for a customer who is a woman in her 30s, wears sportswear, uses a stroller, and is interested in health-oriented products” based on an attribute vector received from the customer attribute analysis unit. The generative AI linkage unit inputs this prompt character string to the large language model to output a text of the advertisement text. The generative AI linkage unit inputs this text to a latent diffusion model to output an image tensor. The generative AI linkage unit constructs a prompt character string “generate a display plan to move product A talked about on SNS this week to the center of the shelf and place product B at eye level” for product display optimization. The generative AI linkage unit inputs this prompt character string to the large language model to output a text of a display instruction. The generative AI linkage unit constructs a prompt character string “generate a demand prediction of product A for next week and an optimal store/EC inventory allocation plan in consideration of a sales history for the past three months, weather information, and event information” for integrated inventory management. The generative AI linkage unit inputs this prompt character string to the large language model to output a text of an allocation plan. The generative AI linkage unit constructs a prompt character string “generate a recommended product description text of a souvenir corner for a tourist speaking Chinese” for multilingual support. The generative AI linkage unit inputs this prompt character string to the large language model to output a Chinese text. The generative AI linkage unit constructs a prompt character string “generate a 3D model in which product A in a furniture sales floor is arranged in a living room of a home, and also create a usage scene video” for augmented reality content generation. The generative AI linkage unit inputs this prompt character string to a 3D generation model and a video generation model to output polygon data and a video frame array. The system thereby abstracts complex inter-system linkage via a natural language interface. The system brings about a technical effect of processing various tasks with a single foundation model. The system provides extremely high flexibility and expandability in a use case of constructing a multimodal AI agent.

The administrator interface unit provides a management screen on which a store operator and a person in charge at a headquarters can browse and operate a customer attribute analysis result, a flow line analysis result, an inventory status, a demand prediction, a display optimization plan, a sales promotion effect analysis, an event effect analysis, external environment information, a proposal content by a generative AI, and the like in real time. For example, it is possible to visualize a popular area in a store with a heat map, analyze a sales transition and an inventory transition with a time-series graph, and approve, correct, and distribute a display plan and a sales promotion plan proposed by the generative AI with one click. Furthermore, an administrator can directly input a prompt text to the generative AI to immediately generate and reflect a unique sales promotion text, event plan, inventory allocation plan, and the like. Specifically, the administrator interface unit is implemented as a single-page application operating on a web browser. The administrator interface unit establishes WebSocket communication with a server to perform bidirectional real-time data synchronization. The administrator interface unit inputs statistical data of a customer attribute and coordinate data of flow line analysis received from a server to a drawing library of a front end. The administrator interface unit maps coordinate data on a floor plan image of a store to render an image layer of a heat map. The administrator interface unit thereby visually visualizes a popular area in a store. The administrator interface unit inputs a time-series array of an inventory status and a demand prediction to a chart drawing component. The administrator interface unit draws a line graph of a sales transition and an inventory transition on a screen. The administrator interface unit displays text data of a display optimization plan and a sales promotion plan output by a generative AI in a list view. The administrator interface unit arranges a UI component of an approval button and a correction button for each proposal. The system detects an event that occurs when an administrator clicks an approval button. The system commits a parameter of an approved proposal to a database. The system asynchronously distributes a parameter to each output device. The administrator interface unit further includes a text input field. The system acquires a unique prompt character string input to an input field by an administrator. The system transmits a prompt character string to a generative AI linkage unit of a server. The system feedback-displays text data of a sales promotion text and an event plan immediately generated by a generative AI on a screen. The system reflects these contents in a production environment after confirmation by an administrator. The system thereby provides a human-machine interface for a human to intuitively understand and control an output of a complex AI system. The system brings about technical effects of reducing a cognitive load of a system operator and accelerating a decision-making process. The system provides an indispensable function in a use case of a data-driven store management dashboard.

As described above, the system according to the present embodiment organically links a customer attribute analysis unit, a product display optimization unit, an integrated inventory management unit, an information output unit, a data collection unit, a generative AI linkage unit, and an administrator interface unit, sequentially inputs specific prompt texts such as “generate an advertisement text and an image of a health-oriented product optimal for a customer who is a woman in her 30s, wears sportswear, and uses a stroller,” “generate a display plan to move a product talked about on SNS to a conspicuous shelf position,” “generate a demand prediction and an inventory allocation plan in consideration of a past sales history and weather information,” “generate a souvenir product description text for a Chinese tourist,” and “generate a 3D model in which product A in a furniture sales floor is arranged in a living room of a home, and a usage scene video” to a generative AI, and reflects an output result of the generative AI to each unit in real time, thereby comprehensively and efficiently realizing improvement in consistency of a customer experience, improvement in efficiency of inventory management and product display, sophistication of management judgment, regional revitalization support, promotion of repeat customer acquisition, minimization of opportunity loss, reduction in business load, and the like at a site of a retail business. Specifically, the system executes each functional module as an independent process using containerization technology. The system manages a life cycle of a container using an orchestration tool. The system loosely couples a customer attribute analysis unit, a product display optimization unit, an integrated inventory management unit, an information output unit, a data collection unit, a generative AI linkage unit, and an administrator interface unit via a message broker. The system asynchronously transmits a prompt character string to an inference endpoint of a generative AI via a RESTful API. For example, the system transmits a prompt character string “generate an advertisement text and an image of a health-oriented product optimal for a customer who is a woman in her 30s, wears sportswear, and uses a stroller”. The system transmits a prompt character string “generate a display plan to move a product talked about on SNS to a conspicuous shelf position”. The system transmits a prompt character string “generate a demand prediction and an inventory allocation plan in consideration of a past sales history and weather information”. The system transmits a prompt character string “generate a souvenir product description text for a Chinese tourist”. The system transmits a prompt character string “generate a 3D model in which product A in a furniture sales floor is arranged in a living room of a home, and a usage scene video”. The system parses response data in a JSON format returned from a generative AI. The system routes a text, an image tensor, and 3D model data included in response data to each output module. The system executes these processes in real time with a latency in milliseconds. The system thereby realizes dynamic and adaptive store operation that was impossible with a conventional batch processing-based system. The system brings about a technical effect of improving consistency of a customer experience at a site of a retail business. The system brings about a technical effect of improving efficiency of inventory management and product display. The system brings about a technical effect of sophisticating management judgment. The system brings about a technical effect of supporting regional revitalization. The system brings about a technical effect of promoting repeat customer acquisition. The system brings about a technical effect of minimizing opportunity loss. The system brings about a technical effect of reducing a business load. The system provides a comprehensive and efficient solution in a use case of constructing a next-generation smart retail platform.

### (Implementation Steps)

### Step 1: Customer Data Collection

Various data such as a face image, a full-body image, a walking speed, a movement route, a stay time, the number of stops, an action in front of a shelf, and the number of product contacts of a visiting customer are acquired in real time using various devices such as an RGB camera, a depth camera, a thermography camera, an infrared sensor, a beacon, a Wi-Fi sensor, and a BLE tag installed at a plurality of locations such as a store entrance, a sales floor, a cash register, an event space, and an aisle. For example, a face image is acquired by an entrance camera, and a flow line and a stay time in front of a shelf of a customer are recorded by a sensor in a sales floor. Specifically, the system includes a clock generator that synchronizes a sampling rate of each device. The system continuously acquires an image tensor of 30 frames per second from an RGB camera. The system measures a time of flight of an infrared pulse from a depth camera to generate matrix data of a depth map. The system detects far-infrared radiation energy from a thermography camera to generate matrix data of a temperature distribution. The system generates a pulse signal from an interruption pattern of an infrared sensor. The system acquires numerical data of a received signal strength indicator from a beacon and a Wi-Fi sensor. The system receives an advertisement packet from a BLE tag. The system temporarily stores these raw data in a ring buffer memory of an edge terminal. The system applies an object detection algorithm to an image tensor to extract bounding box coordinates of a person. The system calculates absolute coordinates of a person in a three-dimensional space in combination with a depth map. The system calculates a velocity vector from time-series coordinate data to derive a walking speed. The system performs spline interpolation on a locus of coordinates to generate vector data of a movement route. The system measures a stay time in a specific coordinate area by a timer interrupt. The system detects a state in which a velocity vector approaches zero and increments a counter of the number of stops. The system extracts key point coordinates of a joint using a skeleton estimation model to generate a locus vector of a hand movement in front of a shelf. The system performs intersection determination between a locus vector of a hand and three-dimensional coordinates of a product to count the number of product contacts. The system thereby quantizes a continuous event in a physical space as discrete digital data with high accuracy. The system brings about a technical effect of providing a highly reliable input feature amount for a subsequent analysis process. The system is applied to a use case of advanced action recognition by sensor fusion.

### Step 2: Preprocessing and Anonymization by Edge Terminal

Acquired image data and sensor data are primarily preprocessed by an in-store edge terminal, and face detection, blurring processing, simple estimation of age and gender, and anonymization of personal information are executed. For example, raw data of a face image is immediately deleted on a terminal side, and only attribute data is transmitted to a server, thereby thoroughly protecting privacy. Specifically, the edge terminal executes a preprocessing pipeline at a high speed at a hardware level using a built-in neural processing unit. The edge terminal applies a cascade classifier using a Haar-like feature amount to an image tensor read from a ring buffer. The edge terminal specifies pixel coordinates of a face area in an image. The edge terminal applies a Gaussian blur, which is a kind of spatial frequency filtering, to a pixel value of a specified face area. The edge terminal generates an anonymized image tensor in which a personal identification feature of a face is physically destroyed. The edge terminal simultaneously inputs raw pixel data of a face area to a lightweight convolutional neural network for mobile. The network outputs a probability distribution vector of an age class and a probability distribution vector of a gender class. The edge terminal extracts a class having a maximum probability to determine scalar values of age and gender. The edge terminal applies a cryptographic hash function such as SHA-256 to a unique identifier such as a MAC address included in sensor data. The edge terminal converts it into an irreversible hash value to completely anonymize personal information. The edge terminal completely erases raw image data and raw sensor data on a volatile memory by zero-padding processing immediately after these processes are completed. The edge terminal generates structured data including an anonymized image tensor, a scalar value of an attribute, and a hashed identifier. The edge terminal encrypts structured data with a TLS protocol and transmits it to a server. The system thereby dramatically reduces a data transfer amount to a cloud side. The system brings about a technical effect of preventing depletion of a network bandwidth. The system plays an extremely important role in a use case of secure data collection compliant with personal information protection legislation.

Step 3: Customer attribute analysis and profile generation (utilization of generative AI) A generative AI on a server integrally analyzes a preprocessed face image, full-body image, flow line data, purchase history, point card information, SNS linkage information, and the like, estimates age, gender, facial expression, clothing, belongings, walking speed, circulation pattern, stay time, the number of product contacts, and the like with high accuracy, and automatically generates a detailed profile for each customer. As a specific example of a prompt text to be read by the generative AI, “Estimate a purchase tendency and an interested product of this customer from the following attribute data (age: 30s, gender: female, clothing: sportswear, belongings: stroller, flow line: entrance→beverage corner→confectionery corner→cash register, stay time: 5 minutes at the beverage corner), and generate a profile” is given. Specifically, the server inputs the received structured data to a feature engineering module. The module inputs tensors of the face image and the full-body image to a pre-trained ResNet model to extract a high-dimensional image feature vector. The module inputs a coordinate array of the flow line data to a recurrent neural network to extract a time-series feature vector. The module normalizes numerical data of the purchase history and the point card information to generate a scalar feature. The module inputs text data of the SNS linkage information to a BERT model to extract a text feature vector. The server concatenates these heterogeneous feature vectors in a concatenation layer to generate a single integrated feature vector. The server inputs the integrated feature vector to a multilayer perceptron. The multilayer perceptron outputs a probability distribution vector of a facial expression class, a clothing class, and a belongings class. The server extracts a label with the highest probability from the probability distribution vector. The server combines the extracted label with numerical values of the walking speed, the circulation pattern, the stay time, and the number of product contacts to generate intermediate data in a JSON format. The server converts the intermediate data into a natural language prompt character string using a template engine. For example, the server constructs a prompt character string “Estimate a purchase tendency and an interested product of this customer from the following attribute data: age 30s, gender female, clothing sportswear, belongings stroller, flow line from entrance to beverage corner to confectionery corner to cash register, stay time 5 minutes at beverage corner, and generate a profile”. The server inputs this prompt character string to a large language model based on a transformer architecture. The large language model calculates a contextual dependency between input tokens using a self-attention mechanism. The large language model autoregressively generates a profile text describing a potential need and an interested product of the customer. The system thereby dynamically constructs a complex customer persona that cannot be captured by rule-based conditional branching. The system brings about a technical effect of dramatically improving the accuracy of personalization. The system is extremely effective in a use case of advanced customer segmentation.

Step 4: Personalized advertisement/product information generation (utilization of generative AI) A generative AI generates optimal product information and advertisement information for each customer based on a customer profile using a natural language generation model and an image generation model. For example, a prompt text such as “Generate an advertisement text and a usage scene image of a low-carbohydrate sports drink for a customer who is a female in her 30s, wears sportswear, uses a stroller, and is interested in health-oriented products” is input to the generative AI, and an advertisement text and an image image such as “Please try a limited-time low-carbohydrate drink” and “A healthy beverage that can be enjoyed by the family” are generated. Specifically, the server inputs the generated profile text to a prompt generator. The prompt generator adds a system prompt to the profile text to construct a final input character string. For example, the prompt generator constructs an input character string “Generate an advertisement text and a usage scene image of a low-carbohydrate sports drink for a customer who is a female in her 30s, wears sportswear, uses a stroller, and is interested in health-oriented products”. The server inputs this input character string to a large language model which is a natural language generation model. The large language model applies a multi-layer transformer block to a token embedding vector of the input character string. The large language model outputs a text character string of a catch copy optimized for an attribute of a target customer. For example, the large language model outputs a text “Please try a limited-time low-carbohydrate drink”. The large language model outputs a text “A healthy beverage that can be enjoyed by the family”. The server further inputs the output text character string to a text encoder of a latent diffusion model which is an image generation model. The text encoder converts the text character string into a conditioning vector. The latent diffusion model iteratively executes a denoising step using a U-Net architecture with a random noise tensor as an initial state. The latent diffusion model generates a latent representation tensor having a feature along the conditioning vector. The latent diffusion model inputs the latent representation tensor to a decoder to output a high-resolution RGB image tensor. For example, the latent diffusion model outputs an image image tensor in which a woman wearing sportswear is drinking a drink while pushing a stroller. The server integrates the generated text character string and the image tensor to generate advertisement content data in an HTML format. The server transmits the advertisement content data to a display terminal in the store to render it on a screen. The system thereby completely automates a creative production process. The system brings about a technical effect of reducing a lead time of content generation to zero. The system provides an innovative solution in a use case of real-time one-to-one marketing.

Step 5: Information distribution to displays and terminals Information such as an advertisement text, a product description text, an image, and a video generated by a generative AI is distributed in real time to a display terminal in a store, an on-shelf display, an electronic shelf label, a tablet next to a cash register, a smartphone, a tablet, and the like. For example, when a customer approaches a beverage corner, a display automatically displays “This week's recommended healthy beverage” and the like, and contents are immediately switched according to an attribute and a flow line of the customer. Specifically, the system dynamically converts multimedia data output by a generative artificial intelligence model in accordance with display specifications of each terminal. The conversion processing unit receives a text token sequence and a high-dimensional image tensor. The conversion processing unit encodes the received data into bitmap data and a video stream suitable for a screen resolution and a color depth of each terminal. The system asynchronously transmits the converted data to an edge terminal group using a publish-subscribe messaging protocol. The edge terminal works in conjunction with a short-range wireless communication beacon and a depth camera arranged in the store. The edge terminal constantly monitors a radio wave intensity signal and three-dimensional point cloud data indicating an approach of a customer. The edge terminal detects that a distance between the customer and the terminal falls below a predetermined threshold. The edge terminal transmits a display update request to a server triggered by this detection event. Upon receiving the request, the server immediately reads a profile vector of the customer from a memory. The server inputs the profile vector as conditioning data to a large language model and an image generation model. The large language model generates a text character string matching a preference of the customer based on the input vector. The image generation model generates an RGB image tensor with high visual appeal based on the input vector. The system integrates the generated text and image to construct layout data for display. The system push-distributes the constructed layout data to a target display terminal with a low latency in milliseconds. The display terminal expands the received data in a video memory. The display terminal instantaneously rewrites drawing contents of a screen. By this processing, the system realizes extremely highly responsive personalized information presentation that follows a movement and an attribute change of a customer. The system exhibits a technical effect of eliminating a visual delay while minimizing consumption of a network bandwidth. The system functions extremely effectively in a use case such as a dynamic digital signage advertisement and an interactive product guidance system in a retail store.

Step 6: Product display/replenishment data collection The number of inventory, a product take-out/replenishment history, sales performance for each shelf, a turnover rate for each product, a customer stay time in front of a shelf, the number of product contacts, and the like are acquired in real time from a weight sensor, an RFID reader, an infrared sensor, a camera, and the like installed on each product shelf, primarily aggregated by an in-store terminal, and then transmitted to a server. Specifically, the system acquires continuous analog signals and digital data from a heterogeneous sensor group deployed in a physical space in a store. The weight sensor outputs a time-series voltage signal indicating a load change of a product shelf. The edge terminal converts the voltage signal into discrete numerical data using a built-in analog-to-digital conversion circuit. The edge terminal applies a smoothing algorithm such as a Kalman filter to remove environmental noise from the numerical data. The edge terminal accurately calculates an increase or decrease in mass accompanying take-out or replenishment of a product from the weight data after noise removal. The radio frequency identification reader reads a unique identification code from a tag attached to a product via a radio wave. The edge terminal executes an anti-collision algorithm to prevent data loss during simultaneous reading of a plurality of tags. The camera outputs a high-resolution video stream capturing an action of a customer in front of a shelf. The edge terminal extracts skeletal coordinates and a bounding box of a hand of the customer from each frame of the video stream using a convolutional neural network. The edge terminal measures the number of times the customer contacts a product and a time stayed in front of the shelf in milliseconds based on the extracted coordinate data. The edge terminal aggregates these multidimensional sensor data for each certain time window. The edge terminal serializes the aggregated data into a lightweight data description language format. The edge terminal transmits the serialized data to a cloud server via an encrypted communication channel. The system dramatically reduces an amount of data to be transmitted to the server by executing advanced primary processing on an edge side. The system exhibits a technical effect of preventing congestion of a communication network and improving throughput of the entire system. The system realizes real-time digitization of a physical state in a use case such as an unmanned checkout store and a highly automated inventory management warehouse.

Step 7: Product display optimization instruction generation (utilization of generative AI) A generative AI on a server integrally analyzes various external data such as inventory data, sales performance, weather information, event information, past sales transition, sales trends of neighboring stores, and SNS trend information, and automatically optimizes a display position and a priority of each product according to top-selling products and an inventory status. As a specific example of a prompt text to be read by the generative AI, “Generate a display plan to move product A, which is a hot topic on SNS this week, to the center of a shelf, and arrange product B at eye level”, “Generate a promotional text recommending replenishment for product C whose inventory has decreased”, and the like are given. Specifically, the server integrates collected various structured data and unstructured data to construct a high-dimensional input tensor. The server normalizes numerical data indicating the number of inventory and sales performance to convert it into a feature vector. The server converts text data such as weather information and event information into a word embedding vector using a natural language processing model. The server concatenates these vectors and supplies them to an input layer of a large language model. The large language model adopts a transformer architecture. The large language model calculates a complex correlation between input data using a self-attention mechanism. The large language model extracts, for example, a hidden causal relationship between a past sales transition and current social media trend information. The server executes an optimization algorithm to calculate an ideal display coordinate and a priority score of each product. The server embeds a calculation result in a natural language prompt text. The server generates a structured prompt including, for example, a product identifier, a current shelf coordinate, a target shelf coordinate, and a recommendation reason. The large language model receives this prompt. The large language model outputs text data indicating a specific display change procedure and a catch copy for sales promotion in accordance with an instruction of the prompt. Output data of the large language model includes a three-dimensional vector group indicating a new arrangement coordinate of each product and character string data of a promotional text. The server maps the output three-dimensional vector group to a three-dimensional virtual model of a store. The server verifies whether a dimensional constraint and a weight limit of a physical shelf are satisfied based on a mapping result. If there is a constraint violation, the server requests the large language model to regenerate using a penalty function. The system simultaneously processes an enormous amount of variables that are difficult for a human to grasp to derive an optimal physical arrangement. The system exhibits a technical effect of eliminating personalization of display work and automating data-driven decision making for sales maximization. The system is applied to a use case such as automatic design of a dynamic sales floor configuration in a supermarket or an apparel store.

Step 8: Information reflection on electronic shelf labels and signage A display plan, a promotional text, an inventory status, the number of remaining items, limited sale information, and the like generated by a generative AI are automatically reflected on an electronic shelf label and digital signage. For example, a promotional text such as “Special price only for now”, “3 items remaining”, and “Hot product on SNS” is displayed in real time. Specifically, the server converts text data and numerical data output by a generative artificial intelligence model into a format suitable for hardware specifications of each display device. The server renders text data into a bitmap image for a low-resolution monochrome or multi-color electronic paper display for an electronic shelf label. The server automatically executes optimization of a font size and adjustment of contrast during rendering. The server synthesizes text data and a background image to generate a high-resolution video stream and dynamic web content for digital signage. The server transmits the generated display data to a gateway device installed in a store. The gateway device multicast-distributes data to thousands of electronic shelf labels using a unique low power consumption wireless communication protocol. The gateway device monitors an acknowledgment response from each electronic shelf label. The gateway device executes data retransmission processing for an electronic shelf label in which a communication error has occurred. The electronic shelf label converts the received bitmap data into a drive voltage pattern of a display using a built-in microcontroller. The electronic shelf label physically rewrites a pixel state of the display. The system immediately activates this series of update processing upon detecting a trigger event such as a fluctuation in the number of inventory or a start of a time sale. The system synchronizes all display devices in the store with an accuracy in milliseconds. The system exhibits a technical effect of preventing a discrepancy in price display and ensuring transparency of information for a customer. The system realizes extremely high operational efficiency in a use case such as a fresh food sales floor with severe price fluctuations and a retail store implementing a flash sale.

Step 9: Integrated inventory/demand prediction data collection Inventory data of a physical store (such as the number of inventory for each shelf, a replenishment history, and a return history) and inventory data of an electronic commerce site (such as warehouse inventory, a shipping history, and a return history) are integrated in real time and aggregated in a server. Specifically, the server continuously extracts data from a plurality of physically distributed heterogeneous database systems. The server receives a transaction log from a point-of-sale information management system of the physical store via an asynchronous messaging queue. The server acquires an inventory fluctuation history in a warehouse in a JSON format from a back-end server of the electronic commerce site via an application programming interface. The server executes schema mapping processing on the acquired data group. The server converts a product code and a data type that are inconsistent between different systems into a unified internal format. The server executes data cleansing processing to complement a missing value and exclude an abnormal value. The server stores the normalized data in a distributed key-value store or a graph database. The server uses a transaction control mechanism such as a two-phase commit protocol in database update processing. The server guarantees strict consistency between the inventory data of the physical store and the electronic commerce site. The server calculates the total number of inventory of each product, an allocation amount for each store, and the number of inventory in transit in real time. The server caches a calculation result in an in-memory database to minimize a data read delay in subsequent demand prediction processing. The system integrates siloed inventory information as a single reliable information source. The system exhibits a technical effect of accurately grasping an excess or deficiency of inventory in an omnichannel environment and preventing an opportunity loss. The system provides an indispensable foundation for a use case such as integrated supply chain management in a large-scale retail chain having both a physical store and an online store.

Step 10: Demand prediction/inventory allocation optimization (utilization of generative AI) A generative AI on a server analyzes various data such as a past sales history, seasonal factors, weather information, promotion information, event information, and regional characteristics, predicts future demand with high accuracy, and automatically optimizes inventory allocation to a physical store and an electronic commerce site. As a specific example of a prompt text to be read by the generative AI, “Generate a demand prediction and an optimal store/EC inventory allocation plan for product A next week in consideration of a sales history for the past three months, weather information, and event information”, “Generate a movement/replenishment instruction to prevent out-of-stock and overstock”, and the like are given. Specifically, the server constructs integrated inventory data and external environment data as a multivariate time-series tensor. The server inputs this tensor to a deep learning-based demand prediction model. The demand prediction model adopts a long short-term memory network or a transformer architecture. The demand prediction model simultaneously learns a long-term dependency and a short-term fluctuation of a past sales pattern. The demand prediction model receives a daily sales number vector for the past 100 days, a temperature prediction vector for one week in the future, and a binary array of a promotion execution flag as input data. The demand prediction model generates a probability distribution of a demand prediction value at each future time step as output data. The server calculates an expected value of this probability distribution to acquire a predicted demand amount vector of each product. The server inputs the predicted demand amount vector and a current inventory distribution matrix to an inventory allocation optimization algorithm. The algorithm optimizes an objective function that minimizes a transportation cost and an inventory holding cost using linear programming or reinforcement learning. The server calculates an allocation matrix indicating an optimal inventory movement amount between each store and a warehouse as a result of optimization. The server converts this allocation matrix and a prediction result into a natural language prompt text. The server inputs the converted prompt text to a large language model. The large language model generates a specific business instruction text that is easy for a human to understand based on the input numerical data and context information. The large language model outputs, for example, an instruction on how many products should be moved from a specific warehouse to a specific store and a sentence logically explaining a reason thereof. The system fuses advanced mathematical optimization and natural language generation. The system exhibits a technical effect of automating a complex supply chain decision-making process and dramatically improving an inventory turnover rate. The system plays a core role in a use case such as dynamic inventory relocation and an automatic ordering system in a logistics network deployed nationwide.

Step 11: Visualization and operation by administrator interface An administrator interface unit visualizes a customer attribute analysis result, a flow line analysis result, an inventory status, a demand prediction, a display optimization plan, a sales promotion effect analysis, an event effect analysis, external environment information, a proposal content by a generative AI, and the like output by the generative AI in real time with a graph, a heat map, a time-series chart, and the like so that an operator can browse and operate them. An administrator can also input a unique prompt text to the generative AI to immediately generate and reflect a promotional text, an event plan, an inventory allocation plan, and the like. Specifically, the administrator interface unit receives a high-dimensional analysis data stream continuously transmitted from a server. The interface unit executes a dimensionality reduction algorithm such as principal component analysis or t-distributed stochastic neighbor embedding. The interface unit maps a multidimensional customer attribute vector and flow line data to two-dimensional or three-dimensional spatial coordinates. The interface unit dynamically renders a color gradation heat map image indicating a congestion degree and a stay time in a store using kernel density estimation based on the mapped coordinate data. The interface unit draws a time-series tensor of demand prediction as an interactive line graph or bar graph using a web graphics library. The interface unit includes a drill-down function of pop-up displaying a detailed parameter behind a specific data point when the administrator selects the specific data point via an input device. The interface unit receives a natural language text prompt input from the administrator. The interface unit transmits the input prompt to a large language model on the server by asynchronous communication. The large language model analyzes an intention of the prompt and immediately infers a requested variation of a promotional text and a new inventory allocation matrix. The interface unit displays an inference result returned from the large language model in a designated area on a screen in real time. Upon detecting that the administrator has pressed an approval button, the interface unit commits a setting value thereof to a setting database of the entire system. The system converts a complex internal state of an artificial intelligence and an enormous calculation result into intuitively understandable visual information. The system exhibits a technical effect of providing a seamless interactive interface between a human administrator and an artificial intelligence model and improving a speed and accuracy of decision making. The system functions as a powerful management tool in a use case such as daily operation management in a back office of a store and a dashboard system for management.

Step 12: Multilingual/tourist/augmented reality information generation (utilization of generative AI) A generative AI determines a language attribute and a tourist attribute of a customer, and automatically generates product information, advertisement information, tourist guidance, event information, augmented reality content, and the like in multiple languages. As a specific example of a prompt text to be read by the generative AI, “Generate a recommended product description text of a souvenir corner for a tourist who speaks Chinese”, “Generate a 3D model and a usage scene video in which product A in a furniture sales floor is arranged in a living room at home”, and the like are given. Specifically, the server executes an attribute classification neural network with a language setting of a smartphone terminal of the customer and a past purchase history vector as input. The classification network outputs a score indicating a mother tongue of the customer and a probability of being a tourist. The server determines an optimal language code based on this score. The server inputs basic information extracted from a product database and the determined language code to a sequence-to-sequence transformer model. The transformer model translates and adapts an input text into a text token sequence of a target language with high accuracy using an encoder-decoder architecture. Upon receiving a generation request for augmented reality content, the server reads three-dimensional CAD data and a texture image of a target product from a memory. The server supplies these data as a conditioning input to a three-dimensional object generation model. The generation model dynamically generates vertex coordinate data and a material property indicating a variation in color and shape of the product according to a prompt and an attribute of the customer. The server integrates the generated three-dimensional data and multilingual text to construct a scene description file for augmented reality. The server streaming-distributes this file to a terminal of the customer. The customer terminal executes a self-position estimation and environmental map creation algorithm on a video stream from a built-in camera. The customer terminal detects a plane in a real space and superimposes and draws the generated three-dimensional object with a correct perspective. The system realizes immersive information presentation completely adapted to a cultural background and a physical environment of the customer in real time. The system exhibits a technical effect of strongly arousing a willingness to buy by eliminating a language barrier and visually and intuitively transmitting an appeal of a product. The system provides an innovative customer experience in a use case such as a virtual fitting in a duty-free shop in an international airport or a large furniture store.

### (Specific Use Case)

For example, when the system of the present invention is introduced into a retail chain developing a plurality of stores in an urban area, first, an RGB camera, a depth camera, an infrared sensor, a beacon, a Wi-Fi sensor, and a BLE tag are installed at a store entrance, a main sales floor, around a cash register, an event space, an aisle, and the like, and data such as a face image, a full-body image, a walking speed, a movement route, a stay time, the number of stops, an action in front of a shelf, and the number of product contacts of a visiting customer are acquired in real time. For example, a face image acquired by an entrance camera is subjected to face detection and blurring processing by an in-store edge terminal, and after simple estimation of age and gender and anonymization of personal information are performed, the face image is transmitted to a server. A generative AI on the server integrally analyzes the face image, the full-body image, flow line data, a purchase history, point card information, SNS linkage information, and the like, estimates age, gender, facial expression, clothing, belongings, walking speed, a circulation pattern, the stay time, the number of product contacts, and the like with high accuracy, and generates a detailed profile for each customer. For example, when generating a profile indicating a woman in her 30s, sportswear, use of a stroller, a long stay at a beverage corner, and an interest in health-oriented products, a prompt text “Age: 30s, Gender: female, Clothing: sportswear, Belongings: stroller, Flow line: entrance→beverage corner→confectionery corner→cash register, Stay time: 5 minutes at the beverage corner. Estimate a purchase tendency and an interested product of this customer from this information, and generate a profile.” is input to the generative AI. Specifically, the present system captures a multimodal data stream of several tens of frames per second from a sensor network stretched around a store space. The present edge terminal synchronizes an image tensor from the RGB camera and a distance matrix from the depth camera. The present edge terminal extracts a human face region and a full-body bounding box from the image tensor using a convolutional neural network. The present edge terminal applies an irreversible hash function or a mosaic processing algorithm to the extracted face region to convert privacy information into a physically unrestorable state. The present edge terminal executes a lightweight inference model to calculate a probability distribution of an age group and a gender from an anonymized feature amount vector. The present edge terminal packetizes these preprocessed data and a time-series array of position coordinates obtained from the beacon, and transmits them to a cloud server. The present server associates the received time-series array and image feature amount vector with a customer identifier and stores them in an integrated database. The present server inputs these integrated data to a multimodal-compatible transformer model. The present transformer model processes an embedding vector of an image patch and an embedding vector of text data in the same latent space. The present transformer model learns a correlation between a visual feature of the customer's clothing and a spatial feature of the movement route using a cross-attention mechanism. The present transformer model outputs a profile vector of several hundred dimensions representing a current state and a potential need of the customer based on the input data. The present server decodes this profile vector into a natural language description to construct a prompt text. The present server inputs the constructed prompt text to a large language model to execute logical inference. The present large language model derives a conclusion that the customer has a high probability of being interested in health-oriented products from the input action history and attribute information. The present system converts fragmentary physical sensor data into a highly abstracted semantic profile. The present system exhibits a technical effect of completely quantifying customer analysis that has relied on human observation ability and constructing a foundation for scalable personalization. The present system exhibits extremely high accuracy in use cases such as dynamic customer segmentation and real-time behavioral targeting advertisement in a large-scale shopping mall.

Next, the generative AI generates optimal product information and advertisement information for each customer using a natural language generation model and an image generation model based on the customer profile. For example, a prompt text “Generate an advertisement text and a usage scene image of a low-carbohydrate sports drink for a customer who is a woman in her 30s, wears sportswear, uses a stroller, and is interested in health-oriented products.” is input to the generative AI, and an advertisement text such as “Please try a limited-time low-carbohydrate drink.” or “A healthy beverage that can be enjoyed by the family.” and an image image are generated. The generated advertisement text and image are distributed in real time to an in-store display terminal, a shelf-top display, an electronic shelf label, a tablet next to a cash register, a smartphone, a tablet, and the like. For example, when the customer approaches the beverage corner, the display automatically displays “This week's recommended healthy beverage” and the like, and the contents are immediately switched according to the attribute and flow line of the customer. Specifically, the present server inputs the generated customer profile vector as a conditioning parameter to a plurality of generative artificial intelligence models in parallel. The present natural language generation model probabilistically samples a word token matching the profile vector using an autoregressive transformer decoder. The present natural language generation model generates an advertisement text character string that is contextually natural and diverse using a method such as top-P sampling. The present image generation model adopts a latent diffusion model architecture. The present image generation model starts from a random noise tensor and removes noise stepwise according to guidance of the profile vector and a text prompt. The present image generation model outputs a high-resolution RGB image tensor expressing the designated usage scene through this iterative denoising process. The present server synthesizes the generated text character string and image tensor into a display format such as HTML or a video stream. The present server pre-distributes the synthesized content data to a cache memory of an edge computing node. The present edge node tracks current position coordinates of the customer in units of milliseconds in conjunction with a positioning system in the store. The present edge node determines that the position coordinates of the customer have entered a polygon indicating a display effective range of a specific display terminal. The present edge node immediately push-transmits the cached content data to the target display terminal triggered by this entry event. The present display terminal expands the received data in a frame buffer and instantaneously updates display contents of a screen. The present system generates a creative perfectly adapted to the attribute and context of the customer on demand and presents it without delay. The present system exhibits a technical effect of eliminating uniform advertisement display and dramatically improving a customer engagement degree and a purchase conversion rate. The present system provides a core value in use cases such as personalized signage and an interactive product recommendation kiosk in a smart retail environment.

Furthermore, the number of inventory, a product take-out/replenishment history, sales performance for each shelf, a turnover rate for each product, a customer stay time in front of a shelf, the number of product contacts, and the like are acquired in real time from a weight sensor, an RFID reader, an infrared sensor, a camera, and the like installed on each product shelf, primarily aggregated by an in-store terminal, and then transmitted to the server. The generative AI on the server integrally analyzes various external data such as inventory data, sales performance, weather information, event information, past sales transition, sales trends of neighboring stores, and SNS trend information, and automatically optimizes a display position and a priority of each product according to top-selling products and an inventory status. For example, a prompt text “Generate a display plan to move product A, which is a hot topic on SNS this week, to the center of the shelf, and arrange product B at eye level.” or “Generate a promotional text recommending replenishment of product C, whose inventory has decreased.” is input to the generative AI, and a specific display change instruction or replenishment instruction such as “Move product A to the center of the shelf”, “Arrange product B at eye level”, or “Replenishment of product C is recommended because only a few remain” is notified to a person in charge through a management tablet or a smartphone terminal. In cooperation with an electronic shelf label or digital signage, a product price, a promotional text, an inventory status, the number of remaining items, limited sale information, and the like are also automatically switched. For example, a promotional text such as “Special price only for now”, “Only 3 left”, or “Hot product on SNS” is displayed in real time. Specifically, the present system constructs a sensor network topology with each shelf in the store as a node. Each present node continuously samples an analog voltage value from the weight sensor and a video frame from the camera. The present edge terminal applies a feature extraction algorithm to these raw data and converts them into discrete time-series data indicating the number of increase/decrease of products and a customer contact event. The present edge terminal minimizes a communication payload using a data compression algorithm and transmits it to the server by a secure communication protocol. The present server combines the received physical data with weather data and a social media trend score acquired from an external web application programming interface. The present server inputs this combined data as a multidimensional tensor to a large language model and an optimization algorithm. The present optimization algorithm evaluates an objective function that maximizes an expected sales value while satisfying spatial constraints such as physical dimensions and load capacity of the shelf. The present optimization algorithm calculates optimal three-dimensional arrangement coordinates and a replenishment priority score of each product. The present server inserts this calculation result into a natural language prompt template and supplies it to the large language model. The present large language model interprets the input numerical data and context, and generates a specific action instruction text for store staff and a promotional text for customers. The present server structures the generated action instruction text into task data in a JSON format. The present server transmits this task data as a push notification to a dedicated application of a smart device carried by the store staff. The present server transmits the simultaneously generated promotional text and price change data to an electronic shelf label of a target product and nearby digital signage. The present electronic shelf label drives a segment of a built-in electronic paper display based on the received data to physically rewrite display contents. The present system immediately embodies an advanced inference result in a cyber space as a layout change or a display update in a physical space. The present system exhibits a technical effect of speeding up a PDCA cycle of store operation to the utmost limit and achieving both minimization of opportunity loss and improvement of labor productivity. The present system exhibits tremendous power in use cases such as dynamic sales floor management in an apparel store with severe demand fluctuations or a supermarket handling daily delivered goods.

In addition, inventory data of a physical store (such as the number of inventory for each shelf, a replenishment history, and a return history) and inventory data of an electronic commerce site (such as warehouse inventory, a shipping history, and a return history) are integrated in real time and aggregated in the server. The generative AI on the server analyzes various data such as a past sales history, seasonal factors, weather information, promotion information, event information, and regional characteristics, predicts future demand with high accuracy, and automatically optimizes inventory allocation to the physical store and the electronic commerce site. For example, a prompt text “Generate a demand prediction and an optimal store/EC inventory allocation plan for product A next week in consideration of a sales history for the past three months, weather information, and event information.” or “Generate a movement/replenishment instruction to prevent out-of-stock and overstock.” is input to the generative AI, and a demand prediction, an inventory allocation result, and a movement/replenishment instruction are notified to a management terminal. Specifically, the present server continuously synchronizes transaction data from a point-of-sale information management system of the physical store and a back-end system of the electronic commerce site using a distributed database system. The present server integrates inventory records of both systems into a single logical data warehouse using a data replication mechanism. The present server inputs the integrated past sales history vector, time-series tensor of weather information, and binary array of event flags to a demand prediction neural network. The present demand prediction network adopts an ensemble learning architecture that integrates outputs of a plurality of prediction models. The present demand prediction network outputs a probability distribution tensor indicating a demand prediction value for each future time step of each product. The present server inputs this prediction tensor to a linear programming solver for solving an optimal transport problem. The present solver calculates an optimal inventory movement amount matrix that minimizes an overall inventory holding cost and opportunity loss cost with a transport cost matrix between respective bases and an inventory accommodation capacity of each base as constraint conditions. The present server inputs this matrix data and a feature amount importance score indicating a prediction basis to a natural language generation model. The present natural language generation model generates a specific business instruction text such as “Move 50 products A from warehouse X to store Y” and a report text explaining a logical reason thereof based on the input data. The present server transmits the generated text data and graph data for visualization to a dashboard terminal of an administrator in real time. The present system integrates siloed inventory data and combines advanced mathematical optimization and inference by artificial intelligence. The present system exhibits a technical effect of eliminating uneven distribution of inventory in the entire supply chain and improving cash flow. The present system provides an indispensable function in use cases such as construction of a centralized inventory control tower in a retail company promoting an omnichannel strategy.

Furthermore, the generative AI determines a language attribute and a tourist attribute of the customer, and automatically generates product information, advertisement information, tourist information, event information, augmented reality content, and the like in multiple languages. For example, a prompt text “Generate a recommended product description text of a souvenir corner for a tourist speaking Chinese.” or “Generate a 3D model and a usage scene video in which product A in a furniture sales floor is arranged in a home living room.” is input to the generative AI, and a multilingual product description, tourist information, and augmented reality content for foreign tourists are displayed on a display or a smartphone. Specifically, the present server executes an attribute classifier with a history vector of locale information and position information transmitted from the customer's terminal as an input. The present classifier calculates a probability that the customer is a tourist speaking a specific language using a support vector machine or a deep neural network. The present server determines an identification code of a target language when this probability score exceeds a threshold value. The present server inputs metadata extracted from a product database and the determined language code to a multilingual-compatible large language model. The present large language model generates a natural text token sequence of the target language while retaining an original meaning using a cross-lingual embedding space. The present server loads three-dimensional mesh data and a texture map of the product into a graphics pipeline in response to a generation request for augmented reality content. The present server receives a posture matrix of a camera and point cloud data of an environment transmitted from the customer's terminal. The present server dynamically executes light source calculation and shadow rendering processing of a three-dimensional model based on these spatial data. The present server streaming-transmits the rendered image frame and three-dimensional object data to the customer's smartphone or augmented reality glasses with low latency. The present customer terminal synthesizes the received data with an actual camera video in real time and outputs it to a frame buffer of the display. The present system automatically recognizes a context of the customer and performs information presentation eliminating linguistic and visual barriers. The present system exhibits a technical effect of dramatically improving quality of a purchase experience while reducing a customer service cost for inbound customers. The present system has extremely high practicality in use cases such as a multilingual-compatible virtual concierge in a retail store or a large showroom in an international tourist destination.

As described above, the system of the present invention realizes advanced automation of store operation and optimization of a customer experience by sequentially inputting specific prompt texts such as “Estimate a purchase tendency and an interested product from customer attribute data, and generate a profile.”, “Generate an optimal advertisement text and image based on a profile.”, “Generate a display plan and a promotional text from inventory, sales, and external data.”, “Generate a demand prediction and an inventory allocation plan from a sales history, weather, and event information.”, and “Generate a multilingual product description text for tourists.” to the generative AI in each phase such as customer attribute analysis, personalized advertisement generation, product display optimization, inventory integration/demand prediction, information output, and multilingual/tourist/augmented reality support, and reflecting an output result of the generative AI to each unit in real time. Specifically, the present system adopts a microservice architecture and executes each functional module as an independent container on an orchestration platform. The present system performs event-driven data linkage between respective modules via an asynchronous message queuing system. The present system constructs a series of data pipelines from input of sensor data to execution of inference of an artificial intelligence model and output to a physical device. The present system calls a plurality of neural networks such as a large language model and an image generation model in the right place at the right time in each processing phase. The present system dynamically generates a high-dimensional tensor and a structured prompt text as input data to each model. The present system immediately converts a text token sequence, a probability distribution, a three-dimensional vector, an image tensor, and the like, which are output data from each model, into a format interpretable by a subsequent processing module or a physical actuator. The present system executes these conversion processing and communication processing with a latency in units of milliseconds. The present system processes countless variables generated in a complex physical environment of a store in real time and continuously issues an optimal control command. The present system exhibits a technical effect of optimizing all aspects of store operation in a data-driven manner at a level exceeding limits of human cognitive ability and processing speed. The present system establishes a use case as a next-generation smart retail foundation that realizes completely autonomous operation of a retail store as a cyber-physical system, not limited to mere automation of business.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments of the present invention will be described more specifically and in detail. A distribution center operation system of the present invention is composed of a plurality of functional units such as a worker attribute analysis unit, an inventory layout optimization unit, a flow line navigation unit, a demand prediction unit, a data collection unit, an administrator interface unit, and a generative AI linkage unit, and each unit is distributed and implemented in a server and a field terminal (such as an edge terminal, AR glasses, a smartphone, a tablet, and a management PC). A generative AI that integrates the whole is essential, and advanced automation and optimization of a logistics site are realized by linkage of each unit. Specifically, the present distribution center operation system adopts a hybrid distributed processing architecture in which an edge computing node and a cloud server group are coupled by a broadband network. The present system implements each functional unit as an independent software module and dynamically deploys it on each hardware resource using a container virtualization technology. The present system incorporates a lightweight inference engine and a data preprocessing module into augmented reality glasses and a smartphone which are field terminals. The present system arranges a generative artificial intelligence group responsible for heavy arithmetic processing such as a transformer-based large language model of a scale of hundreds of billions of parameters and a graph neural network on a cloud server. The present generative AI linkage unit functions as an application programming interface gateway. The present linkage unit queues an inference request asynchronously transmitted from each functional unit and routes it to an appropriate artificial intelligence model. The present linkage unit returns an output result of the artificial intelligence model to the requesting functional unit via a callback function. The present system processes a huge sensor data stream in real time by this multi-agent system-like cooperative operation. The present system reconstructs physical states of people, objects, and equipment in the distribution center as a digital twin in a cyber space with high accuracy. The present system exhibits a technical effect of dynamically and globally optimizing a complex logistics operation that cannot be handled by a single control logic using an inference ability of artificial intelligence. The present system functions as a core operating system in use cases such as a large-scale fulfillment center for electronic commerce handling tens of thousands of products and a highly automated parts supply warehouse in a manufacturing industry.

The worker attribute analysis unit collects various data such as a face image, a full-body image, a motion video, vital data (such as heart rate, body temperature, blood pressure, number of steps, fatigue degree, sweating amount, and sleep history), a work history, qualification information (such as forklift qualification, hazardous materials handling qualification, years of picking experience, inspection skill, and packing skill), a past work tendency, a break history, an accident history, and a health checkup result for each worker in the distribution center in real time. For example, when a worker passes through an entrance gate, identity verification is performed by a face recognition camera, and at the same time, heart rate and body temperature data are acquired from a wearable terminal. During work, biological information and motion data are acquired in real time from a smartwatch or work clothes with a vital sensor worn by the worker, and a work history such as picking, transportation, inspection, and packing is also automatically recorded. For example, when worker A performs picking work 30 times, forklift driving 10 times, and inspection work 5 times in the morning, these histories are recorded in chronological order. Furthermore, when the worker operates a forklift or an automated guided vehicle, qualification information and a past driving record are also linked and managed. For example, it is recorded that worker B has a forklift qualification and has had no accidents in the past year. These data are primarily processed by an edge terminal, and after anonymization of personal information, noise removal, and the like are performed, the data are transmitted to the server. The generative AI on the server integrally analyzes these multidimensional data, estimates years of experience, qualifications, physical fitness level, work speed, health condition, proficient work area, condition of the day, work efficiency, accident risk, stress level, and the like of each worker with high accuracy, and generates a detailed profile in real time. For example, individual optimization is also possible, such as worker C having an average speed of picking work in the top 10% of the whole, having a high physical fitness level, and having a history of back pain in the past, so heavy object work should be avoided. Furthermore, it is determined that worker D is elderly but has high accuracy in inspection work and has an aptitude for detailed work. Specifically, the present worker attribute analysis unit receives a biological signal and a video stream continuously output from a wearable device and an environmental camera. The present analysis unit handles time-series data of a heart rate and an acceleration sensor as a one-dimensional tensor. The present analysis unit handles a video frame from the camera as a three-dimensional tensor. The present edge terminal applies a low-pass filter or a moving average algorithm to these tensor data to remove high-frequency noise. The present edge terminal extracts a skeletal coordinate vector of the worker from the video tensor and converts a face image feature amount into an irreversible hash value to protect privacy. The present edge terminal streaming-transmits the preprocessed tensor data and structured data of the work history to the cloud server. The present server integrates the received heterogeneous data to construct a high-dimensional state vector unique to each worker. The present server inputs this state vector to a multimodal neural network including a long short-term memory network and a transformer encoder. The present network simultaneously learns a long-term dependency of a past work history and a short-term fluctuation of current vital data. The present network outputs a current fatigue degree score, a stress level, and an aptitude score for a specific task of the worker as continuous values from 0.0 to 1.0 based on the input data. The present server further executes an anomaly detection algorithm such as an isolation forest to calculate a probability of a potential health risk or accident risk from a rapid change in vital data. The present server combines these output scores and a record of a qualification information database to generate a dynamic profile of the worker. The present system quantifies an ability and a state of the worker based on objective biological data and action data without depending on subjective evaluation of a human. The present system exhibits a technical effect of realizing advanced task assignment that achieves both ensuring safety of the worker and maximizing labor productivity. The present system functions extremely effectively in use cases such as optimal allocation of human resources and safety management monitoring in a large-scale logistics facility where labor shortage is serious.

The inventory layout optimization unit acquires the number of inventory, a storage position, a receiving and shipping history, a turnover rate for each shelf, a picking frequency, a replenishment history, a temperature management history, a storage condition for each product, and the like of each product in real time from an RFID reader, a weight sensor, an inventory management system, a receiving and shipping gate sensor, a temperature and humidity sensor, and the like installed on each shelf and storage area in the distribution center. For example, detailed data such as 50 products X are stored on shelf A, 30 products Y are stored on shelf B, product X was picked 20 times in the past week, product Y was replenished 5 times, and shelf C is a dedicated area for pharmaceuticals requiring temperature management are collected. Furthermore, a past shipping/receiving history, seasonal factors (summer, winter, busy season, off-season), weather information (rain, extreme heat, snowfall), sale and event information (large sale, campaign, regional event), and external demand data (ordering tendency from business partners, consumer demand prediction, traffic conditions, disaster information, and the like) are also acquired from the outside. The generative AI integrally analyzes these data and predicts future demand in units of days and time zones with high accuracy. For example, a prediction is made that demand for beverages and cooling goods rapidly increases during fine weather in summer, and a shipping volume of a specific product becomes twice as much as usual during a sale period. Based on a demand prediction result and a current inventory layout, the generative AI automatically generates an optimal inventory layout plan for moving a product with high picking frequency to a shelf near a shipping gate or a main aisle. For example, by relocating product X, whose demand rapidly increases this week, near the shipping gate of shelf A, and product Y to the aisle side of shelf B, a movement distance and time of picking work are minimized. Furthermore, for a product with a risk of overstock or out-of-stock, an action plan such as replenishment, movement, and promotion enhancement is also automatically generated. For example, a specific instruction such as “Promotion enhancement is recommended” when product Z is overstock, or “Emergency replenishment from headquarters warehouse is instructed” when product W is at risk of out-of-stock is generated. Specifically, the present inventory layout optimization unit models a physical layout in a warehouse as graph structure data composed of nodes and edges on a memory. The present optimization unit assigns a current inventory number vector and temperature history data acquired from a sensor group as attribute values to a shelf which is each node. The present optimization unit converts weather data and event information acquired from an external application programming interface into a feature amount vector. The present optimization unit inputs this feature amount vector and a past shipping history tensor to a transformer model for demand prediction. The present transformer model calculates a weight of an influence of seasonal factors and weather fluctuations on demand for a specific product using a self-attention mechanism. The present transformer model outputs a probability distribution of a demand prediction value for each product at each future time step. The present optimization unit inputs this demand prediction value and current graph structure data to a graph neural network and a reinforcement learning algorithm. The present reinforcement learning algorithm sets a reward function that minimizes a total movement distance and a picking time of a worker. The present algorithm searches for an optimal node allocation matrix of each product that maximizes a reward while satisfying weight, volume, and storage temperature constraints of the product. The present optimization unit calculates a specific product movement procedure for shifting from a current layout to an optimal layout based on this matrix data. The present optimization unit inputs this movement procedure data and an evaluation score of an inventory risk to a large language model. The present large language model generates a specific movement instruction text for a worker and an action plan for an administrator in a natural language based on the input numerical data. The present system continuously executes dynamic spatial optimization anticipating future demand fluctuations instead of static rule-based layout. The present system exhibits a technical effect of dramatically reducing a walking distance of picking work and improving throughput of the entire warehouse. The present system provides an indispensable function in use cases such as dynamic location management in a distribution center handling apparel merchandise with severe seasonal fluctuations and food with strict freshness management.

The flow line navigation unit integrally analyzes a worker profile, a work task of the day (such as a picking list, a replenishment instruction, inspection work, packing work, inventory work, and cleaning work), a warehouse map (such as a shelf layout, an aisle width, a shipping gate position, dangerous area information, an emergency exit position, and a forklift-only aisle), a congestion status of a site (such as real-time human flow data, an operation status of a forklift, a congestion degree of an aisle, a distribution of workers, and obstacle information), inventory layout information, work progress, vital data, a fatigue level and a stress level of a worker, and the like by a generative AI, and automatically generates an optimal work order and route for each worker. For example, the flow line navigation unit preferentially assigns picking of a heavy object and replenishment work of a large shelf to a worker who has a high physical fitness level and a forklift qualification, and presents a shortest route of “entrance→shelf A→shelf C→shipping gate” as a work route. On the other hand, the flow line navigation unit assigns picking of a lightweight product and inspection work to a worker who is anxious about physical fitness, and presents a safe and efficient route of “entrance→shelf B→shelf D→inspection area”. The congestion status and the dangerous area information are also reflected in real time, and dynamic navigation such as “recommending a route avoiding via shelf D because the vicinity of shelf C is currently congested”, “temporarily stopping because a forklift is passing”, and “guiding another route because an obstacle is detected near an emergency exit” is also possible. An AR navigation with multilingual support created by the generative AI is displayed in real time on AR glasses or a smartphone worn by the worker. For example, instructions such as “Please proceed to shelf A and pick product X. Next, please move to shelf C.” and “Please transport this product with a forklift because it is a heavy object.” are displayed in Japanese, English, Chinese, and the like. The progress and the vital data of the worker are also monitored in real time, and an alert is transmitted to an administrator if there is an abnormality. For example, when the heart rate of the worker rapidly increases or when the work progress is remarkably delayed, a notification such as “detecting a physical condition abnormality of worker A, recommending a break” or “progress delay of worker B, requesting additional support” is automatically transmitted to a management terminal. Specifically, the flow line navigation unit expresses a space in the warehouse as a three-dimensional grid map, and dynamically allocates a passage cost and a weighting factor of a congestion degree to each cell. The navigation unit inputs a worker profile vector and structured data of a task list to a task assignment algorithm. The algorithm calculates an optimal combination of tasks that minimizes a total work completion time with a skill level and a fatigue score of the worker as constraint conditions. The navigation unit inputs a destination coordinate group of the assigned task and a current grid map to a dynamic routing algorithm. The algorithm calculates a shortest route vector avoiding an obstacle and a congested area using an extended version of an A-star search algorithm or deep reinforcement learning. The navigation unit inputs the route vector and task contents to a large language model. The large language model generates a specific instruction text token sequence translated according to a language profile of the worker. The navigation unit streams and transmits the generated text and the route vector to augmented reality glasses worn by the worker. The augmented reality glasses execute self-position estimation and an environmental map creation algorithm on an image of a built-in camera. The augmented reality glasses superimpose and draw a virtual arrow object and an instruction text on a floor surface of an actual aisle or a space of a shelf based on the calculated self-position coordinates. The navigation unit constantly monitors a vital data stream of the worker and detects an abnormal pattern such as a rapid increase in a heart rate. The navigation unit immediately recalculates a route upon detecting an abnormality, generates a guidance route to a safe break area, and transmits an emergency interrupt notification to an administrator terminal. The system reflects a physical situation of the site and a physiological state of the worker, which change moment by moment, in route calculation in real time. The system exhibits a technical effect of eliminating a traffic jam in the warehouse and dramatically improving safety while reducing a cognitive load of the worker. The system exhibits extremely high practicality in use cases such as advanced fleet management and pedestrian navigation in an ultra-large-scale distribution center where hundreds of workers and a large number of automated guided vehicles coexist.

The demand prediction unit analyzes a past shipping and receiving history, seasonal factors, weather, sale and event information, external demand data, a business partner ordering tendency, a traffic condition, disaster information, social conditions, and the like by a generative AI, and predicts demand for each product with high accuracy on a daily basis and a time zone basis. For example, the demand prediction unit makes a prediction such as “demand for beverage products will increase by 30% because the temperature will be high next week”, “a shipping volume of home appliance products will double a normal volume during a large-scale sale period”, and “demand for disaster prevention goods will rapidly increase when a typhoon approaches”, and links the prediction to an inventory layout optimization unit and a flow line navigation unit. Specifically, the demand prediction unit constructs a multivariate time-series tensor by integrating a wide variety of data acquired from an internal database and an external data provider. The prediction unit combines a numerical vector indicating a past shipping volume, a continuous value tensor of weather forecast data, and an array obtained by one-hot encoding a categorical variable of event information. The prediction unit inputs the combined high-dimensional tensor to a deep learning prediction model equipped with an attention mechanism. The prediction model learns an interaction between long-term periodicity of time-series data and a sudden external factor. The prediction model outputs a probability density function of a demand amount of each product at a specific future time step based on input data. The prediction unit calculates an expected value and a confidence interval from the probability density function, and generates a predicted demand matrix. The prediction unit inputs the matrix data and an importance score of a feature amount that is a basis of prediction to a large language model. The large language model interprets the input numerical data and context, and generates a prediction report text in a natural language understandable by a human. The prediction unit asynchronously transmits the generated prediction matrix and report text to the inventory layout optimization unit and the flow line navigation unit via a messaging queue. The system executes advanced inference considering a complex external factor instead of a simple prediction on an extension of the past. The system exhibits a technical effect of enhancing responsiveness of a supply chain to a rapid fluctuation in demand and simultaneously reducing an out-of-stock risk and an overstock risk. The system provides an indispensable prediction infrastructure in use cases such as supply chain management of consumer goods in which a rapid demand spike due to a sudden weather disaster or a viral effect of SNS is likely to occur.

The data collection unit collects various data from a camera, a sensor, a wearable device, an RFID reader, a POS system, an inventory management system, and an external API (such as weather information, event information, demand prediction data, traffic information, and disaster information) in real time, performs preprocessing, anonymization, and noise removal at an edge terminal, and then aggregates the data in a server. For example, the data collection unit acquires a shipping history for each product from the POS system, the number of inventory for each shelf from the RFID reader, vital data of a worker from the wearable device, and a weather forecast, event holding information, traffic congestion information, disaster occurrence information, and the like from the external API. Specifically, the data collection unit constructs a data pipeline constantly connected to thousands of IoT devices distributed and arranged in a physical space and an external web service. The collection unit receives a data stream based on an MQTT or HTTP protocol transmitted from each device at an edge gateway. The edge gateway executes adjustment of a sampling rate and normalization processing of a data format on received raw data. The edge gateway detects an abnormal value and a missing value from sensor data using a lightweight machine learning model such as an autoencoder, and complements the abnormal value and the missing value with an algorithm such as spline interpolation. The edge gateway applies an irreversible cryptographic hash function to a face region of a person extracted from a camera image, and converts the face region into a feature vector that cannot identify an individual. The edge gateway serializes preprocessed data into a JSON format, and transmits the serialized data to a distributed message broker of a cloud server via a secure communication channel subjected to TLS encryption. The server routes the received data to a real-time stream processing engine, and stores the data in an in-memory database or a data lake for long-term storage. The system intelligently filters and compresses a huge amount of raw data on an edge side. The system exhibits a technical effect of ensuring data quality and security of the entire system while dramatically reducing consumption of a communication bandwidth to the cloud server. The system provides an extremely robust and scalable infrastructure in use cases such as construction of a large-scale data collection infrastructure in a smart factory or a logistics network deployed over a wide area.

The administrator interface unit provides a management screen on which a distribution center administrator and a site leader can browse and operate a worker attribute analysis result, an inventory status, a demand prediction, work progress, a flow line optimization plan, an abnormality detection alert, proposal contents by a generative AI, and the like in real time. For example, the administrator interface unit can visualize a congested area in a warehouse with a heat map, analyze a shipping volume and an inventory transition with a time-series graph, and approve, correct, and distribute an inventory layout plan and a work assignment plan proposed by the generative AI with one click. Furthermore, the administrator can directly input a prompt text to the generative AI, and immediately generate and reflect a unique work instruction, an inventory movement plan, an alert condition, and the like. For example, a prompt such as “generate an optimal shelf layout plan from a demand prediction and an inventory status of this week” or “generate and transmit an alert text to an administrator when a vital abnormality of worker A is detected” is used. Specifically, the system executes bidirectional data communication via the administrator interface unit. The processing unit performs a differential update of a screen using a virtual document object model. In drawing a heat map, the system holds a congestion degree at each coordinate in the warehouse as a two-dimensional array. The processing unit maps a value of each element of the two-dimensional array to a color space gradient. The system transfers mapped color information to a graphics processing unit. The graphics processing unit renders a color on the screen using a pixel shader. In drawing a time-series graph, the system expands time-series data acquired from a database into a memory as a one-dimensional vector. The processing unit calculates a maximum value and a minimum value of the one-dimensional vector, and dynamically determines a drawing scale of the graph. The system inputs a prompt text input from the administrator to a natural language processing model. The processing unit divides an input character string into word units using a morphological analyzer. The processing unit collates each divided word with a dictionary database. The processing unit converts each word into a corresponding integer identifier. The processing unit inputs an array of integer identifiers to an embedding layer. The neural network converts the integer identifier into a high-dimensional continuous value vector. Input data is, for example, a 768-dimensional floating-point tensor. The input data includes a semantic feature and position information of a word. As a specific example, the input data includes a vector of a word “optimization” and a vector of a word “execution”. The neural network calculates an inner product between vectors using a plurality of self-attention layers. The neural network extracts a feature representation according to a context. The neural network calculates a final prediction probability using a fully connected layer. The neural network outputs a command token having a maximum prediction probability. Output data is hierarchical structured data composed of a key-value pair. The output data indicates a function name to be executed and a list of arguments. As a specific example, the output data includes a movement instruction that is a function name and shelf A that is an argument. The system inputs the output data to a parser. The system calls an internal application programming interface based on a result of parsing. The system returns a call result to the administrator interface unit. The system pop-up displays the returned result on the screen. Thereby, the system converts an intuitive instruction of the administrator into an accurate system control command. The system automates complex parameter setting work and reduces an operation error. The system dramatically improves operational efficiency of the distribution center. The system is widely applicable to an optimization task of inventory management and personnel allocation in a large-scale warehouse.

The generative AI linkage unit integrates various data input from each unit, and bears advanced information processing such as worker profile generation, demand prediction, inventory layout optimization, flow line navigation generation, abnormality detection, natural language generation, image generation, and multilingual translation. For example, a prompt such as “generate an optimal work order and route from attribute data of worker A and a task of today”, “generate an optimal shelf layout plan from a demand prediction and an inventory status of this week”, and “generate and transmit an alert text to an administrator when a vital abnormality of worker B is detected” is used. Specifically, the system executes multimodal information integration processing in the generative AI linkage unit. The linkage unit inputs text data, image data, and sensor data to independent encoders, respectively. The processing unit projects a feature vector output from each encoder into the same latent space. The system combines projected feature vectors and generates an integrated tensor. Input data is, for example, a 1024-dimensional multidimensional tensor. The input data includes vital information of a worker, current task contents, and congestion degree information in a warehouse. As a specific example, the input data includes a numerical vector indicating a heart rate and a word embedding vector indicating task contents. The neural network learns a correlation between different modalities using a cross-attention mechanism. The neural network collates instruction contents of a text with a current state of a sensor. The neural network infers an optimal action plan based on a collation result. The neural network inputs an inference result to a decoder. The neural network generates a specific control command and a natural language text through the decoder. Output data is an array of floating-point numbers and a set of character strings. The output data indicates a score of an optimal solution of each task and a generated alert text. As a specific example, the output data includes 0.95 that is a recommendation score of route A and a warning message notifying a poor physical condition. The system compares a score of the output data with a threshold. The system transmits an action plan whose score exceeds the threshold to a subsequent control module. The system inputs the generated text to a multilingual translation model, and translates the text into a native language of the worker. The system distributes the translated text to a wearable terminal. Thereby, the system integrally interprets heterogeneous data, and realizes autonomous decision-making based on advanced context understanding. The system enables real-time site support without intervention of a human administrator. The system minimizes an information transmission delay and improves safety of work. The system functions extremely effectively in a large-scale manufacturing base and an international logistics hub where multinational workers coexist.

As described above, the embodiment of the present invention realizes total optimization and advanced automation of a distribution center site, such as real-time attribute analysis and health management for each worker, dynamic inventory layout optimization based on demand prediction, individually optimized work instruction and flow line navigation according to worker characteristics and a site situation, site support by multilingual and AR support, abnormality detection and an immediate alert, and flexible operation and instruction generation by an administrator, using a generative AI, and comprehensively provides efficiency, flexibility, safety, and diversity that are difficult to achieve by conventional static and manual operation. Specifically, the system aggregates a high-dimensional feature vector output from each subsystem in a central integrated database. The processing unit constructs a status matrix of the entire site using the aggregated feature vector. The system inputs the status matrix to an objective function. The processing unit defines a linear combination formula combining minimization of a total work time, minimization of a movement distance, and minimization of a worker fatigue level as the objective function. The system searches for a parameter group that minimizes the objective function using a nonlinear optimization solver. The processing unit iteratively updates a target value of a next state of each entity using a gradient descent method. The system feeds back the optimized parameter group to each control module. The system continuously executes this feedback loop in a cycle of milliseconds. The system preferentially allocates computing capability to an inference task with a high load using a dynamic allocation algorithm of a computing resource. The processing unit independently scales a process of each module using a container virtualization technology. The system guarantees data consistency among a plurality of modules using a transaction management function of a distributed database. The system adopts an eventual consistency model and enhances fault tolerance against a network delay. Thereby, the system achieves not only local optimization but also global optimization of the entire distribution center based on a mathematical basis. The system extracts a hidden efficiency pattern that cannot be discovered by human intuition by utilizing nonlinear mapping in a high-dimensional space. The system autonomously and immediately adapts to a sudden environmental change that cannot be handled by a conventional rule-based system. The system achieves both reduction of a calculation amount and reduction of latency, and realizes stable operation in a large-scale real environment. The system is applied to a wide range of industrial fields as a base technology for a smart factory and next-generation supply chain management.

### (System Configuration)

The system according to the present embodiment comprises a worker attribute analysis unit, an inventory layout optimization unit, a flow line navigation unit, a demand prediction unit, a data collection unit, an administrator interface unit, and a generative AI linkage unit. The worker attribute analysis unit collects various data such as a face image, a full-body image, a motion video, vital data, a work history, qualification information, a past work tendency, a break history, an accident history, and a health checkup result for each worker in a distribution center in real time, performs, for example, identity verification by a face recognition camera at an entrance gate, acquisition of a heart rate, a body temperature, the number of steps, and a sweating amount from a smart watch or work clothes with a vital sensor during work, automatic recording of a work history such as picking, transportation, inspection, and packing, linking of an operation history of a forklift or an automated guided vehicle and qualification information, and reference to a past accident history and a health checkup result, transmits these multidimensional data to a server after preprocessing and anonymizing the multidimensional data at an edge terminal, and a generative AI on the server estimates years of experience, qualifications, a physical fitness level, a work speed, a health condition, a proficient work area, a condition of the day, work efficiency, an accident risk, a stress level, and the like with high accuracy, and generates a detailed profile in real time. For example, individual optimization such as “worker A has a forklift qualification, an average speed of picking work is in the top 10% of the whole, a physical fitness level is high, and heavy object work should be avoided because of a history of lower back pain” is possible. Specifically, the system executes analysis processing of multidimensional time-series data in the worker attribute analysis unit. The analysis unit inputs vital data transmitted from a wearable device to a one-dimensional convolutional neural network. The analysis unit inputs a face image and a full-body image acquired from a camera to a two-dimensional convolutional neural network. The neural network extracts a feature in a frequency domain from time-series data. The neural network extracts a feature of a spatial edge and a texture from image data. The processing unit combines each extracted feature vector in a fully connected layer. Input data is, for example, a time-series array of 100 steps times 5 dimensions and an image tensor of 224 times 224 times 3 dimensions. The input data includes heart rate variability data for the past one minute and a current facial expression image. As a specific example, the input data includes array data of a heart rate and matrix data of RGB pixel values. The neural network passes the combined feature vector through a plurality of hidden layers. The neural network applies a rectified linear unit as an activation function, and learns a nonlinear relationship. The neural network applies a softmax function in an output layer. The neural network calculates a probability distribution belonging to each attribute category. Output data is a one-dimensional vector storing a probability score of each attribute. The output data indicates an estimated value of a physical fitness level, a stress level, and a fatigue level. As a specific example, the output data includes 0.88 that is a probability that a physical fitness level is high and 0.12 that is a probability that a stress level is high. The system compares the probability score of the output data with a preset threshold. The system extracts an attribute exceeding the threshold as deterministic profile information. The system converts the extracted profile information into structured data composed of a key-value pair. The system writes the structured data into a worker master table of a database. The system immediately notifies a task assignment module of the updated profile information. Thereby, the system realizes objective and quantitative worker evaluation that does not depend on human subjectivity. The system discovers a potential health risk of a worker at an early stage, and prevents an occupational accident. The system enables task assignment perfectly matching individual ability, and maximizes productivity of the entire site.

The inventory layout optimization unit acquires the number of inventory, a storage position, a receiving and shipping history, a turnover rate for each shelf, a picking frequency, a replenishment history, a temperature management history, a storage condition for each product, and the like of each product from an RFID reader, a weight sensor, an inventory management system, a receiving and shipping gate sensor, a temperature and humidity sensor, and the like installed on each shelf and storage area in a distribution center in real time, collects detailed data such as, for example, 50 products X on shelf A, 30 products Y on shelf B, shelf C being a dedicated area for pharmaceuticals requiring temperature management, shelf D being a dedicated area for large products, and shelf E being a dedicated area for high-frequency picking products, acquires a past shipping and receiving history, seasonal factors, weather information, sale and event information, external demand data, a traffic condition, disaster information, and the like from the outside, a generative AI integrally analyzes these data to predict future demand with high accuracy on a daily basis and a time zone basis, automatically generates an optimal inventory layout plan for moving a product with high picking frequency to a shelf near a shipping gate or a main aisle based on a demand prediction result and a current inventory layout, and generates a specific instruction such as, for example, “relocating product X whose demand rapidly increases this week near a shipping gate of shelf A, and product Y to an aisle side of shelf B”, “recommending promotion enhancement because product Z is overstock”, and “instructing emergency replenishment from a headquarters warehouse because product W has an out-of-stock risk”. Specifically, the system executes spatial optimization processing using a graph neural network in the inventory layout optimization unit. The optimization unit constructs a physical layout in a warehouse as graph structured data on a memory. The processing unit defines each shelf as a node, and defines a movement route between shelves as an edge. The processing unit allocates a feature vector to each node. Input data is matrix data of the number of nodes times a feature dimension. The input data includes the current number of inventory of each shelf, a turnover rate of a product, and a physical constraint condition. As a specific example, the input data includes a numerical value indicating the number of inventory of shelf A and a numerical value indicating a load capacity limit of shelf B. The neural network exchanges a feature amount between adjacent nodes using a message passing algorithm. The neural network learns a local inventory bias and a spatial dependency through a plurality of times of message passing. The neural network generates an embedding representation of the entire graph. The system combines the generated embedding representation and a demand prediction vector, and inputs the combined representation and vector as a state space of a reinforcement learning model. The model defines a combination of a movement source and a movement destination of each product as an action space. The model defines a reduction amount of a total picking time and a penalty of a movement cost as a reward function. The model calculates an action value that maximizes an expected reward using a policy gradient method. The model outputs an instruction matrix of an optimal layout change. Output data is a two-dimensional integer array. The output data indicates a combination of a movement source node identifier, a movement destination node identifier, and a movement quantity. As a specific example, the output data includes a command group of moving 20 products X from shelf A to shelf B. The system transmits the output instruction matrix to a control system of an automated guided vehicle. The system automatically executes a physical inventory movement task via the control system. Thereby, the system dynamically solves a complex spatial optimization problem that cannot be handled by a static rule base. The system mathematically minimizes a movement distance of picking work, and dramatically improves work efficiency. The system contributes to full automation of inventory management in a large-scale logistics warehouse and a parts supply center.

The flow line navigation unit integrally analyzes a worker profile, a work task of the day (such as a picking list, a replenishment instruction, inspection work, packing work, inventory work, and cleaning work), a warehouse map (such as a shelf layout, an aisle width, a shipping gate position, dangerous area information, an emergency exit position, and a forklift-only aisle), a congestion status of a site (such as real-time human flow data, an operation status of a forklift, a congestion degree of an aisle, a distribution of workers, and obstacle information), inventory layout information, work progress, vital data, a fatigue level and a stress level of a worker, and the like by a generative AI, automatically generates an optimal work order and route for each worker, preferentially assigns picking of a heavy object and replenishment work of a large shelf to a worker who has a high physical fitness level and a forklift qualification and presents a shortest route of “entrance→shelf A→shelf C→shipping gate”, assigns picking of a lightweight product and inspection work to a worker who is anxious about physical fitness and presents a safe and efficient route of “entrance→shelf B→shelf D→inspection area”, reflects the congestion status and the dangerous area information in real time and enables dynamic navigation such as “recommending a route avoiding via shelf D because the vicinity of shelf C is currently congested”, “temporarily stopping because a forklift is passing”, and “guiding another route because an obstacle is detected near an emergency exit”, and an AR navigation with multilingual support created by the generative AI is displayed in real time on AR glasses or a smartphone worn by the worker, and instructions such as “Please proceed to shelf A and pick product X. Next, please move to shelf C.” and “Please transport this product with a forklift because it is a heavy object.” are displayed in Japanese, English, Chinese, and the like. Specifically, the system executes route search processing using deep reinforcement learning in the flow line navigation unit. The navigation unit divides a two-dimensional plane in a warehouse into fine grid cells, and generates an environment map. The processing unit allocates a passage cost to each grid cell. The processing unit dynamically updates the passage cost according to a congestion degree and presence or absence of an obstacle. The system inputs the environment map and a current state of a worker as a state vector to a reinforcement learning model. Input data is, for example, a 256-dimensional continuous value vector. The input data includes current coordinates of the worker, coordinates of a destination, and surrounding obstacle information. As a specific example, the input data includes XY coordinate values of a current location and an obstacle flag within three meters ahead. The neural network extracts a spatial feature of the environment map using a convolutional layer. The neural network integrates the state vector and the spatial feature using a fully connected layer. The neural network calculates a value of an action value function for each movement direction. The neural network outputs a movement direction in which an action value is maximized. Output data is a coordinate sequence of waypoints. The output data indicates an optimal movement route from the current location to the destination. As a specific example, the output data includes a list of target coordinates every second and a coordinate point of a corner. The system transmits the output coordinate sequence to an augmented reality rendering engine. The processing unit executes self-position estimation using a camera image of augmented reality glasses worn by the worker. The processing unit calculates a perspective projection transformation matrix from a three-dimensional space to a two-dimensional screen using a self-position estimation result and waypoint coordinates. The system superimposes and draws a virtual object for navigation in a field of view using the transformation matrix. Thereby, the system immediately adapts to a situation of a site that changes moment by moment, and provides a safe route avoiding a collision risk in real time. The system significantly reduces a cognitive load of the worker, and reduces a picking error. The system is extremely effective for guidance support of a worker in a large-scale facility where complex flow lines intersect.

The demand prediction unit analyzes past shipping and receiving history, seasonal factors, weather, sale and event information, external demand data, business partner ordering tendency, traffic conditions, disaster information, social situation, and the like by a generative AI, predicts demand for each product on a daily basis and a time zone basis with high accuracy, makes predictions such as, for example, “demand for beverage products will increase by 30% because the temperature will be high next week,” “shipping volume of home appliance products will double the normal volume during a large-scale sale period,” and “demand for disaster prevention goods will rapidly increase when a typhoon approaches,” and links with the inventory layout optimization unit and the flow line navigation unit. Specifically, the system executes an autoregressive time series prediction model in the demand prediction unit. The prediction unit acquires past sales performance data and external factor data from a database. The processing unit divides the acquired data by a sliding window method, and generates an input tensor for learning. The processing unit performs a standardization process on each feature amount so as to have zero mean and unit variance. The input data is a multivariate time series tensor of the number of time steps multiplied by a feature amount dimension. The input data includes the past number of sales, a transition of temperature, and an event holding flag. As a specific example, the input data includes a daily sales number array for the past 30 days and a precipitation probability array for the next 7 days. The neural network adds positional encoding to the input tensor, and retains temporal order information. The neural network learns a long-term dependency relationship between past data points using a multi-layer transformer encoder. The neural network assigns a high weight to a correlation between a specific weather pattern and the number of sales by a self-attention mechanism. The neural network sequentially generates a predicted value at each future time step using a decoder. The neural network optimizes parameters using a loss function combining a mean squared error and a mean absolute error. The neural network outputs a confidence interval indicating uncertainty of prediction together with the predicted value. The output data is an array of continuous values and an array of variance values. The output data indicates a predicted demand amount and its variation in each future time zone. As a specific example, the output data includes 50 which is the predicted demand amount at 10:00 tomorrow, and 10 which is its variance value. The system converts the output predicted demand amount according to an input format to the inventory layout optimization unit, and transmits the converted predicted demand amount. When the variance of the predicted value exceeds a preset threshold value, the system determines that the uncertainty of the prediction is high, and transmits a warning flag to the administrator interface unit. Thereby, the system learns a complex non-linear pattern that cannot be captured by a simple statistical method, and realizes demand prediction with extremely high accuracy. The system mathematically minimizes risks of overstock and out-of-stock, and improves cash flow. The system provides an indispensable function for drafting an optimization plan for the entire supply chain in a retail business or a manufacturing business.

The data collection unit collects various data from a camera, a sensor, a wearable device, an RFID reader, a POS system, an inventory management system, and an external API (such as weather information, event information, demand prediction data, traffic information, and disaster information) in real time, performs preprocessing, anonymization, and noise removal in an edge terminal, and then aggregates the data in a server, and acquires, for example, a shipping history for each product from the POS system, the number of inventory for each shelf from the RFID reader, vital data of a worker from the wearable device, and a weather forecast, event holding information, traffic congestion information, disaster occurrence information, and the like from the external API. Specifically, the system executes a distributed edge computing process in the data collection unit. The collection unit establishes a connection with each sensor device using an asynchronous communication protocol. The edge terminal converts an analog signal transmitted from the sensor into digital data using an analog-to-digital converter. The processing unit applies a low-pass filter to the digital data, and removes high-frequency observation noise. The processing unit statistically corrects a measurement error of the sensor using a Kalman filter, and estimates a true physical quantity. The input data is a one-dimensional continuous raw data stream. The input data includes a fluctuation value of radio wave intensity and a voltage value of a temperature sensor. As a specific example, the input data includes a raw signal waveform received by the RFID reader and raw voltage data from a thermistor. The edge terminal synchronizes data of a plurality of sensors having different sampling rates to a common time base. The processing unit complements a blank portion of data due to a loss of a communication packet using a linear interpolation algorithm. The edge terminal applies a face detection algorithm to image data acquired from the camera, and specifies a face region of a person. The processing unit applies an irreversible hash function to the specified face region, and completes anonymization by converting the face region into a feature amount vector that cannot identify an individual. The edge terminal serializes the preprocessed data into a structured format. The edge terminal compresses a payload with a compression algorithm, and saves a communication band. The output data is a cleansed data record to which a time stamp is added. The output data indicates an accurate physical quantity and an occurrence time of the data. As a specific example, the output data includes 20 degrees which is the temperature of the shelf A at 10:00:00, and an anonymized worker identifier. The edge terminal asynchronously transmits the output data to a time series database of a cloud server using a message queuing protocol. Thereby, the system significantly reduces a calculation load and communication traffic of the cloud server. Even when a network delay or disconnection occurs, the system prevents data loss by data buffering on the edge side. The system establishes a robust and scalable data collection infrastructure in a large-scale facility where a huge number of IoT devices operate.

The administrator interface unit provides a management screen on which a distribution center administrator or a site leader can browse and operate a worker attribute analysis result, an inventory status, a demand prediction, work progress, a flow line optimization plan, an abnormality detection alert, a proposal content by a generative AI, and the like in real time, and enables, for example, visualizing a congested area in a warehouse with a heat map, analyzing a shipping volume and an inventory transition with a time series graph, approving, correcting, and distributing an inventory layout plan and a work assignment plan proposed by the generative AI with one click, and allowing the administrator to directly input a prompt text to the generative AI to immediately generate and reflect a unique work instruction, an inventory movement plan, an alert condition, and the like. Specifically, the system executes an asynchronous linkage process between a front end and a back end in the administrator interface unit. The interface unit establishes a continuous bidirectional communication channel with the server using a WebSocket protocol. The processing unit receives an update data stream push-distributed from the back end in real time. The input data is a state update message encoded as a variable-length byte array. The input data includes a congestion degree score of each area and a fluctuation value of the number of inventory. As a specific example, the input data includes numerical data indicating the congestion degree of the area A and the latest number of inventory of the product X. The processing unit decompresses the received byte array on a memory, and parses the byte array into a structured object. The system applies a differential update technique using a virtual document object model, and minimizes a redrawing region of a screen. The processing unit smoothly renders a heat map and a scatter plot having tens of thousands of data points at 60 frames per second using hardware acceleration of a graphics processing unit. The output data is pixel data expanded on a frame buffer. The output data indicates a visual user interface image displayed on a display. As a specific example, the output data includes a red pixel group indicating a congested area and a line graph pixel group indicating an inventory transition. When the administrator types a prompt text into an input form, the system asynchronously transmits an inference request to a natural language processing model of the back end for each keystroke. The processing unit immediately displays a predicted token sequence returned from the model on the screen as an autocomplete candidate. When the administrator clicks an approval button, the system generates an execution command including an identifier of a target work assignment plan, and transmits the execution command to a task scheduler. Thereby, the system instantaneously visualizes a huge amount of site data in a form optimized for human visual characteristics. The system reduces a cognitive load on the administrator, and strongly supports intuitive and rapid decision-making. The system dramatically reduces an education cost for an operation person in charge by replacing a complex system operation with an interactive interface using natural language.

The generative AI linkage unit integrates various data input from each unit, bears advanced information processing such as worker profile generation, demand prediction, inventory layout optimization, flow line navigation generation, abnormality detection, natural language generation, image generation, and multilingual translation, inputs a prompt text such as, for example, “generate an optimal work order and route from attribute data of worker A and today's task,” “generate an optimal shelf layout plan from this week's demand prediction and inventory status,” and “when a vital abnormality of worker B is detected, generate and transmit an alert text to an administrator” to a generative AI, and reflects an output result to each unit in real time. Specifically, the system executes a gateway function of an application programming interface and a task orchestration process in the generative AI linkage unit. The linkage unit stores an inference request asynchronously transmitted from each subsystem in a task queue. The processing unit dynamically sorts tasks in the queue based on a priority flag and a time stamp added to each request. The input data is a message group accumulated in a request queue. The input data includes a dynamically generated prompt character string and execution context information. As a specific example, the input data includes high-priority character string data requesting emergency alert generation and low-priority character string data requesting regular demand prediction. The system evenly dispatches tasks to an inference server group composed of a plurality of graphics processing units using a load balancer. The processing unit quantizes a weight parameter of a large language model according to a memory constraint of the inference server, and improves an inference speed. The neural network analyzes a context of the input prompt text, dynamically selects an optimal sub-model for the requested task, and executes inference. The neural network encodes an inference result into a structured format and outputs the encoded inference result. The output data is hierarchical structured data consisting of a key-value pair. The output data indicates a control parameter and a generated text that can be directly interpreted by each subsystem. As a specific example, the output data includes a route coordinate list for the navigation unit and a translated text for the interface unit. The system executes a schema verification process on the output data, and strictly checks whether a data type and a value range satisfy specifications. The system immediately returns the output data that has passed the verification to a requesting module through a callback function. Thereby, the system efficiently cooperatively operates a plurality of specialized AI models without depending on a single huge model. The system maximizes processing throughput of the entire system, and maintains stable response performance even in a high-load state at a peak time. The system enables seamless addition of a new functional module and update of an existing model without stopping the system.

As described above, the system according to the present embodiment organically links the worker attribute analysis unit, the inventory layout optimization unit, the flow line navigation unit, the demand prediction unit, the data collection unit, the administrator interface unit, and the generative AI linkage unit, realizes overall optimization and advanced automation of a distribution center site using a generative AI, and comprehensively provides efficiency, flexibility, safety, and diversity that are difficult to achieve by conventional static and manual operations. Specifically, the system executes a process of pipelining a data flow between the respective subsystems in the integrated control unit. The system adopts a microservice architecture, and deploys each unit as an independent container. The processing unit routes communication between the respective containers via a service mesh, and transparently performs encryption of communication and traffic control. The input data is status report data periodically transmitted from each subsystem. The input data includes an operation rate, an error occurrence rate, and a processing delay time of each module. As a specific example, the input data includes a numerical value of 99% indicating the operation rate of the navigation unit and a numerical value of 10 milliseconds indicating the processing delay of the prediction unit. The system inputs the status report data to an abnormality detection algorithm, and monitors soundness of the entire system. When detecting that a load is concentrated on a specific module, the processing unit issues a scale-out command to a container orchestration tool. The system defines a global objective function for overall optimization, and integrates a local objective function of each subsystem. The system dynamically calculates a resource allocation optimization parameter of the entire system using a reinforcement learning agent. The output data is a control parameter group in a setting file format. The output data indicates an allocation amount of a CPU core and a memory for each container. As a specific example, the output data includes an instruction to increase CPU allocation to the prediction unit and an instruction to increase memory allocation to the collection unit. The system immediately reflects the output parameter to an infrastructure management layer. Thereby, the system behaves like a single huge intelligent life form that autonomously evolves and adapts, rather than a mere collection of individual functions. The system operates a self-healing function even against an unexpected trouble such as a hardware failure or a network delay, and brings downtime of the entire system close to zero to the utmost limit. The system provides extremely high reliability and availability in a modern advanced logistics infrastructure that requires mission-critical 24/7/365 operation.

### (Implementation Steps)

### Step 1: Worker Data Collection and Preprocessing

For each worker in a distribution center, various data such as a face image, a full-body image, a motion video, vital data (such as heart rate, body temperature, blood pressure, number of steps, sweating amount, and sleep history), a work history, qualification information, a past work tendency, a break history, an accident history, and a health checkup result are collected in real time, data is acquired from a smart watch, work clothes with a vital sensor, a face recognition camera at an entrance gate, a work terminal, and the like, and the data is transmitted to a server after preprocessing, anonymization, and noise removal are performed in an edge terminal. Specifically, the system executes synchronization and a cleansing process of multi-sensor data in the edge terminal. The collection unit continuously reads a minute analog voltage signal from a biometric sensor built in a wearable device. The processing unit converts the voltage signal into discrete digital time series data using an analog-to-digital converter. The processing unit applies a moving average filter to the digital data, and removes high-frequency artifact noise caused by a body movement of the worker. The collection unit acquires a video stream of 30 frames per second from a high-resolution camera installed at the entrance gate. The input data is a raw image frame from the camera and raw waveform data from the sensor. The input data includes a three-dimensional pixel array and a one-dimensional numerical array. As a specific example, the input data includes a 1920×1080×3-dimensional RGB pixel value tensor and raw waveform data of an electrocardiogram. The processing unit applies a cascade classifier to the image frame, and detects a bounding box of a face region from within the image. The processing unit crops the detected face region, performs grayscale conversion and a histogram smoothing process, and normalizes a fluctuation in illumination conditions. The processing unit applies a pre-trained convolutional neural network to the normalized face image, and extracts an abstract feature amount vector that cannot identify an individual. The processing unit applies a cryptographic hash function to the extracted feature amount vector, and generates an irreversible anonymized identifier. The output data is an anonymized feature amount vector and a noise-removed vital data array. The output data indicates only essential information necessary for estimating a health condition and a fatigue degree while protecting personal privacy. As a specific example, the output data includes a face feature vector which is a 512-dimensional floating-point array and an array of heart rates resampled at one-minute intervals. The edge terminal transmits the output data to a cloud server via a secure encrypted communication channel. Thereby, the system completely eliminates a risk of flowing sensitive personal information in plaintext on a network. The system minimizes a processing delay of the entire system and ensures real-time performance by offloading a calculation load on the server side to the edge side.

### Step 2: Worker Profile Generation (Utilization of Generative AI)

A generative AI on a server integrally analyzes the collected multidimensional data, estimates years of experience, qualifications, physical fitness level, work speed, health condition, proficient work area, condition of the day, work efficiency, accident risk, stress level, and the like of each worker with high accuracy, and generates a detailed profile in real time. As a specific example of a prompt text to be read by the generative AI, “Based on worker ID: 123, face image, vital data, work history, qualification information, accident history, and health checkup result, estimate years of experience, qualifications, physical fitness level, work speed, health condition, proficient work area, condition of the day, accident risk, and stress level, and generate a detailed profile.” is given. Specifically, the system executes a semantic integration process of multidimensional data using a large language model in the analysis unit. The processing unit performs a serialization process for embedding the structured data and the feature amount vector received from the edge terminal into a natural language prompt template. The processing unit converts numerical data and a categorical variable into a human-readable text expression, and dynamically generates a prompt character string. The input data is a token sequence obtained by dividing the generated prompt character string in units of subwords. The input data includes lengthy context information extending to thousands of tokens. As a specific example, the input data includes a token of a text “average heart rate 80” and a token of a text “picking speed 100 pieces per hour”. The neural network applies a self-attention mechanism in an encoder layer, and calculates a complex dependency relationship between input tokens. The neural network evaluates a hidden causal relationship between different data sources, such as a correlation between a past accident history and a current fatigue degree, based on a learned weight parameter. The neural network sequentially generates an estimated score for each evaluation item and a text serving as a basis thereof using a decoder layer. The neural network applies a softmax function in an output layer, and calculates a generation probability of each token. The output data is character string data in a JSON format consisting of a key-value pair. The output data indicates a quantitative score and a qualitative reason for each evaluation item. As a specific example, the output data includes a numerical value of a physical fitness level score of 0.9 and a reason text “because fluctuation in heart rate is small”. The system inputs the output character string data to a syntax analyzer, and converts the character string data into an object for database storage. The system updates a record of a worker master table using the converted object. Thereby, the system realizes advanced person profiling considering a context, which is impossible by a simple threshold determination. The system grasps a minute physical condition change and aptitude of each worker in real time, and provides base data for optimal task assignment.

### Step 3: Inventory and Site Data Collection

The number of inventory, a storage position, a receiving and shipping history, a turnover rate for each shelf, a picking frequency, a replenishment history, a temperature management history, a storage condition for each product, and the like of each product are acquired in real time from an RFID reader, a weight sensor, an inventory management system, a receiving and shipping gate sensor, a temperature and humidity sensor, and the like installed in each shelf and storage area in a distribution center, and past shipping and receiving history, seasonal factors, weather information, sale and event information, external demand data, traffic conditions, disaster information, and the like are also acquired from the outside. Specifically, the system executes integration of heterogeneous sensor data and a spatiotemporal index addition process in a sensor fusion unit. The collection unit continuously receives event-driven data asynchronously generated from a sensor network stretched around in a warehouse. The processing unit applies an anti-collision algorithm to an identifier group of tags acquired from the RFID reader, and prevents data loss during simultaneous reading of a plurality of tags. The processing unit estimates three-dimensional spatial coordinates of each tag by a principle of triangulation using the received radio wave intensity indicator. The input data is an asynchronous data stream having a different format for each type of sensor. The input data includes a reading time of a tag, a load value of a weight sensor, and a JSON response from an external API. As a specific example, the input data includes raw data of an RFID at time T and an analog-to-digital conversion value of a weight sensor at time T. The processing unit adds a highly accurate time stamp synchronized using a network time protocol to each data point. The processing unit aligns data from different sensors on the same time axis based on the time stamp. The processing unit smoothes a minute fluctuation in weight data using a Kalman filter, and calculates an accurate inventory increase/decrease number. The system generates an index using a B-tree structure in order to store the integrated data in a spatiotemporal database. The output data is a multidimensional vector record searchable using spatial coordinates and time as keys. The output data indicates an accurate number of inventory and an environmental state in a specific shelf. As a specific example, the output data includes 50 pieces which is a reliable number of inventory of the product X in the shelf A, and 20 degrees which is an ambient temperature thereof. The system writes the output data as a transaction of an inventory management database. Thereby, the system completely eliminates false detection and a measurement error that may occur with a single sensor by mutual complementation of a plurality of sensors. The system constructs a digital twin environment that grasps accurate positions and states of all articles in a vast warehouse with a delay in units of milliseconds.

Step 4: Demand Prediction (Utilization of Generative AI)

A generative AI on a server analyzes past shipping and receiving history, seasonal factors, weather, sale and event information, external demand data, business partner ordering tendency, traffic conditions, disaster information, social situation, and the like, and predicts demand for each product on a daily basis and a time zone basis with high accuracy. As a specific example of a prompt text to be read by the generative AI, “Based on shipping and receiving history for the past 3 months, weather, sale information, external demand data, traffic conditions, and disaster information, generate a demand prediction for each product for next week on a daily basis and a time zone basis.” is given. Specifically, the system executes a multivariate time series prediction process using an autoregressive model in the prediction unit. The processing unit combines past time series data extracted from a database and future covariate data, and constructs an input tensor. The processing unit applies spline interpolation to a missing value, and generates a continuous data series. The processing unit scales a value to a range from 0 to 1 using min-max normalization in order to unify a scale of each feature amount. The input data is a two-dimensional tensor having a dimension of the number of time steps multiplied by the number of feature amounts. The input data includes a transition of past sales performance and future deterministic event information. As a specific example, the input data includes a daily sales array for the past 90 days and a precipitation probability array for the next 7 days. The neural network inputs the input tensor to a convolutional layer in a time direction, and extracts a short-term trend and periodicity. The neural network inputs the extracted feature map to a long short-term memory unit, and updates an internal state while retaining a long-term dependency relationship. The neural network prevents gradient explosion during learning using a gradient clipping technique, and stabilizes convergence of a model. The neural network calculates a predicted value at each future time step through a fully connected layer. The neural network executes Monte Carlo sampling using a dropout layer, and quantifies uncertainty of prediction. The output data is a pair of a mean vector and a variance vector of predicted values. The output data indicates a predicted demand amount and an upper limit and a lower limit of a confidence interval thereof. As a specific example, the output data includes 100 which is a predicted value of a demand amount, and 10 which is a variance value thereof. The system returns the output predicted value to an original scale by an inverse normalization process. When the variance of the predicted value exceeds a certain threshold value, the system determines that prediction accuracy is low, and sets a warning flag prompting an administrator to readjust parameters. Thereby, the system provides robust and highly reliable demand prediction even in a noisy data environment such as a sudden weather change or a fluctuation in social situation. The system provides a prediction result in a format that can be directly input to a subsequent inventory optimization algorithm, and completes an automatic control loop of a supply chain.

Step 5: Inventory layout optimization (utilization of generative AI) The generative AI automatically generates an optimal inventory layout plan for relocating products with high picking frequency to shelves near a shipping gate or a main aisle based on a demand prediction result and a current inventory layout, and also automatically generates an action plan such as replenishment, movement, and promotion enhancement for products with an overstock or out-of-stock risk. A specific example of a prompt sentence to be read by the generative AI is “Generate a shelf layout plan that maximizes picking efficiency and countermeasures against overstock and out-of-stock risks based on the demand prediction result and the current inventory layout.” Specifically, the system executes formulation of a combinatorial optimization problem and heuristic search processing in an optimization unit. The processing unit expands a current inventory layout state in a memory in a matrix format. The processing unit calculates a future picking frequency score of each product using a demand prediction vector. The system formulates a load capacity of a shelf, a volume limit, and a temperature management requirement of a specific product as strict constraint conditions. The system defines minimization of a total picking movement time as an objective function. Input data is a current layout matrix and a demand prediction vector. The input data includes a two-dimensional array having a dimension of the number of shelves multiplied by the number of products. As a specific example, the input data includes quantity data of each product on each current shelf and a demand prediction score for tomorrow. The algorithm generates an initial population of random layout plans using a genetic algorithm. The algorithm evaluates the objective function for each layout plan and calculates a fitness score. The algorithm selects a layout plan with high fitness, applies crossover and mutation operators, and generates a next-generation layout plan. The algorithm repeats this evolutionary process over thousands of generations to search for an approximate solution close to a global optimal solution. The algorithm determines the best layout matrix that minimizes the objective function while satisfying the constraint conditions. Output data is an optimized new layout matrix and a command list of an action plan. The output data indicates the quantity of each product on each shelf after movement and a specific work instruction to be executed. As a specific example, the output data includes layout matrix data after movement and a promotion flag of product Z. The system calculates a difference between the current layout matrix and the new layout matrix. The processing unit generates a list of specific inventory movement tasks from the difference and registers the list in a task queue. The system pre-verifies an execution time of the generated task list using a simulator and confirms that a deadlock does not occur. Thereby, the system solves an NP-hard layout optimization problem in which the amount of calculation explosively increases within a practical time. The system reduces a useless walking distance of a worker to the utmost limit and dramatically improves a processing throughput of the entire distribution center.

Step 6: Work task assignment and flow line navigation generation (utilization of generative AI) The generative AI integrally analyzes a worker profile, a work task of the day, a warehouse map, a congestion status, inventory layout information, work progress, vital data, a fatigue degree and a stress level of a worker, and the like, automatically generates an optimal work assignment and a work order and route for each worker, and creates dynamic navigation reflecting the congestion status and dangerous area information in real time. A specific example of a prompt sentence to be read by the generative AI is “Generate an optimal work assignment, a work order and route, and points to note based on a profile of worker ID: 123, a task of the day, a warehouse map, a congestion status, an inventory layout, work progress, and vital data.” Specifically, the system executes a multi-agent route search algorithm in a navigation unit. The processing unit defines each worker as an autonomous agent and acquires a current position and an assigned task list of each worker. The processing unit constructs a three-dimensional time-expanded network graph in which a time axis is added to a two-dimensional map of a warehouse. The system individually sets parameters of a movement speed and a fatigue accumulation rate based on profile information of each agent. Input data is a current state vector of all agents and dynamic obstacle information of an environment. The input data includes a tensor of the number of agents multiplied by a state dimension. As a specific example, the input data includes current coordinates and destination coordinates of worker A, and a current position and a predicted trajectory of a forklift. The algorithm uses a priority-based route planning method and searches for a shortest route on the time-expanded network in order from an agent with a high priority. The algorithm registers a route of a searched agent as a dynamic obstacle in the network graph, and avoids a collision in a route search of a subsequent agent. The algorithm evaluates not only a route length but also a penalty for passing through a congested area or a worker with a high fatigue degree by incorporating the penalty into a cost function. The algorithm generates a collision-free route list for all agents. Output data is a three-dimensional coordinate list with a time stamp for each agent. The output data indicates target coordinates of each worker and an action to be executed at each time. As a specific example, the output data includes XY coordinates of worker A at time 1 and a picking instruction command at the point. The system individually transmits the generated route list to a mobile terminal of each worker. When an actual movement speed of a worker deviates from a plan by a certain amount or more, the system fires a dynamic reassignment trigger of a task and immediately recalculates a route. Thereby, the system mathematically completely eliminates congestion and collision in a complex environment where a large number of workers and transport equipment are mixed. The system realizes human-centered task assignment considering individual ability differences and a physical condition of the day, and achieves both safety and efficiency at a high level.

Step 7: AR/multilingual navigation distribution and progress/health monitoring AR navigation and work instructions with multilingual support created by the generative AI are distributed in real time to AR glasses or a smartphone worn by a worker, progress and vital data of the worker are monitored in real time, and an alert is transmitted to an administrator if there is an abnormality. For example, instructions such as “Please proceed to shelf A and pick product X. Next, please move to shelf C.” and “Since this product is a heavy object, please transport it with a forklift.” are displayed in Japanese, English, Chinese, and the like, and when there is a heart rate abnormality or a progress delay, notifications such as “Physical condition abnormality of worker ID: 123 detected, break recommended” and “Progress delay of worker ID: 124, additional support requested” are automatically transmitted to a management terminal. Specifically, the system executes an augmented reality rendering engine and real-time stream processing in a distribution unit. The processing unit synchronizes a route list received from a navigation unit and an output of a self-position estimation algorithm using a camera image of the AR glasses. The processing unit matches feature points extracted from the camera image with a pre-constructed three-dimensional point cloud map, and calculates a six-degree-of-freedom posture matrix of the glasses with high accuracy. Input data is an absolute three-dimensional coordinate vector of a waypoint and a posture matrix of the glasses. The input data includes a target position in a space and a line-of-sight direction of a user. As a specific example, the input data includes XYZ coordinate values of the waypoint, and a rotation matrix and a translation vector of a camera. The processing unit multiplies a coordinate transformation matrix from an absolute coordinate system to a camera relative coordinate system, and calculates three-dimensional coordinates of a virtual object. The processing unit maps the three-dimensional coordinates to two-dimensional screen coordinates using perspective projection transformation. Output data is two-dimensional drawing coordinates on a display and pixel data for rendering. The output data indicates an accurate position for drawing an arrow or text on a screen of the AR glasses. As a specific example, the output data includes position information of an X coordinate of 500 and a Y coordinate of 300 on the screen, and a translated instruction text. The system superimposes and displays graphics for navigation on the drawing coordinates, and updates the screen at 60 frames per second. At the same time, the system continuously calculates a moving average of vital data streamed from a wearable device. The processing unit sets an abnormality detection flag when the moving average value deviates from a threshold of an individually set normal range. The system activates a natural language generation model triggered by the abnormality detection flag, dynamically generates an alert text according to a situation, and push-notifies the administrator terminal. Thereby, the system provides an intuitive and easy-to-understand instruction without diverting a line of sight of the worker from a physical work target. The system realizes accurate information transmission beyond a language barrier, and dramatically reduces work mistakes. The system constantly monitors a health condition of the worker, detects signs of overwork or an accident in advance, and enables rapid intervention.

Step 8: Operation and instruction generation by administrator interface An administrator can input an original prompt sentence to the generative AI and immediately generate and reflect a work instruction, an inventory movement plan, an alert condition, and the like through a management screen capable of browsing and operating a worker attribute analysis result, an inventory status, a demand prediction, work progress, a flow line optimization plan, an abnormality detection alert, a proposal content by the generative AI, and the like in real time. For example, prompts such as “Generate an optimal shelf layout plan from a demand prediction and an inventory status of this week” and “When a vital abnormality of worker ID: 123 is detected, generate and transmit an alert text to an administrator” are used. Specifically, the system includes an administrator interface control unit. The system analyzes an input natural language prompt. The system implements a large language model based on a transformer architecture. The large language model has a deep learning network structure in which dozens of encoder layers and decoder layers are stacked. The system receives input data from the administrator. The system acquires a natural language text vector as the input data. The system acquires a worker attribute vector as the input data. The worker attribute vector is a 512-dimensional numerical array including a heart rate, a body surface temperature, and a fatigue degree score. The system acquires an inventory status tensor as the input data. The inventory status tensor is a multidimensional array including a product identifier, three-dimensional position coordinates, and a current quantity. The system acquires a demand prediction time-series array as the input data. The demand prediction time-series array is a one-dimensional array including sales performance for the past 30 days and a predicted value for the future 7 days. The system executes preprocessing on these pieces of input data. The system divides a natural language text into subword units. The system converts the divided tokens into continuous-value embedding vectors. The system normalizes numerical data and time-series data so as to have zero mean and unit variance. The system maps the normalized data to a common feature amount space. For example, the system processes a text input “Generate an optimal shelf layout plan from a demand prediction and an inventory status of this week”. For example, the system processes a text input “When a vital abnormality of worker identification number 123 is detected, generate and transmit an alert text to an administrator”. For example, the system processes a text input “Predict an increase in demand for beverages due to a temperature rise, and optimize a replenishment route”. The large language model calculates a correlation between respective input modalities using a self-attention mechanism. The large language model executes a large-scale parallel matrix operation using a graphics processing unit. The large language model dynamically combines an intention of a text with a physical inventory state and a worker state in a high-dimensional space. The large language model executes inference processing. The large language model generates output data. The large language model generates hierarchical structured data composed of key-value pairs as the output data. The large language model generates an execution certainty score of each command as the output data. The large language model generates a natural language instruction text optimized for a worker as the output data. For example, the large language model outputs an operation instruction code “Target product identifier: beverage A, movement source coordinates: X1Y1Z1, movement destination coordinates: X2Y2Z2” as the output data. For example, the large language model outputs a warning text “Worker 123, please move to a break room immediately” as the output data. For example, the large language model outputs a high certainty score of 0.98 as the output data. The system executes subsequent processing using these output results. The system compares the certainty score with a preset threshold. The system automatically executes a control command when the score exceeds the threshold. The system displays a reconfirmation dialog on a screen of the administrator when the score is less than the threshold. The system transmits the generated instruction text to a wearable terminal possessed by the worker via wireless communication. The system updates an inventory layout schedule table of a database. The system creates a technical effect by these processes. The system converts an ambiguous natural language instruction of a human into a strict machine control command with high accuracy. The system significantly reduces a manual input work of the administrator. The system dramatically improves operational efficiency of the entire system. The system enables a complex situation judgment that cannot be handled by a conventional rule-based conditional branch. The system uses a cross-entropy error function in pre-training of the large language model. The system optimizes a weight parameter of a network using a stochastic gradient descent method. The system fine-tunes a model using instruction history data of an excellent administrator in the past. The system applies reinforcement learning using human feedback. The system thereby continuously improves validity of an output. The system integrates a voice recognition model as an alternative embodiment. The system converts a voice utterance of the administrator into a text vector in real time. The system processes a multimodal input combining a pointing operation on a screen and a natural language using a gesture recognition model. The system exhibits extremely high usefulness in a specific application field of backyard management of a large-scale distribution center or a retail store by these configurations.

### (Specific Use Case)

For example, when the system of the present invention is applied to a large-scale distribution center, first, when a worker passes through an entrance gate, identity verification is performed by a face recognition camera, and at the same time, vital data such as a heart rate, a body temperature, the number of steps, and an amount of sweating is acquired from a smart watch or work clothes with a vital sensor, linked with a worker ID, preprocessed and anonymized by an edge terminal, and then transmitted to a server. When the worker operates a forklift or an automated guided vehicle, qualification information and a past driving record are also automatically recorded. During work, a work history such as picking, transport, inspection, and packing is collected in real time from a work terminal or a wearable device, and a break history, an accident history, a health checkup result, and the like are also integrally managed. The generative AI analyzes these multidimensional data and generates a detailed profile in real time, for example, “Worker ID: 001 has a forklift qualification, an average speed of picking work is in the top 10% of the whole, a physical fitness level is high, and heavy object work should be avoided because of a history of lower back pain”. As a specific example of a prompt sentence at this time, “Estimate years of experience, qualifications, a physical fitness level, a work speed, a health condition, a proficient work area, a condition of the day, an accident risk, and a stress level based on worker ID: 001, a face image, vital data, a work history, qualification information, an accident history, and a health checkup result, and generate a detailed profile.” is given. Specifically, the system executes cooperative distributed processing between an edge device group and a cloud server in an integrated processing unit. The edge terminal applies a convolutional neural network to a face image acquired from a camera at an entrance gate, and extracts a face feature vector. The processing unit calculates a cosine similarity between the extracted face feature vector and a registered vector in a database, and completes high-speed identity verification. The edge terminal continuously collects vital data from a wearable device with low power consumption using a Bluetooth Low Energy communication protocol. Input data is a combined tensor of a face feature vector, a time-series array of vital data, and a work history log. The input data is configured as a 1024-dimensional multidimensional tensor. As a specific example, the input data includes an embedding representation vector of a face and numerical data indicating an average value of a heart rate. The system converts the combined tensor into a text prompt and inputs the text prompt to an encoder of a large language model. The neural network extracts complex context information such as a correlation between a past history of lower back pain and a current task load using a self-attention mechanism. The neural network generates a text comprehensively evaluating an aptitude and a health condition of a worker using a decoder. Output data is structured text data and a probability score of each evaluation item. The output data indicates detailed profile information of the worker. As a specific example, the output data includes 0.95 which is a forklift aptitude score and a warning flag indicating that a heavy object work risk is high. The system stores the generated profile data in a database and immediately applies the profile data as an input parameter of a task assignment module. Thereby, the system converts a huge amount of raw data obtained from a wide variety of IoT devices into meaningful advanced intelligence. The system grasps individual characteristics with extremely high resolution, and constructs a next-generation work environment in which humans and machines optimally cooperate. The system provides an innovative solution that simultaneously maximizes safety, efficiency, and employee satisfaction in operation of a large-scale facility.

Next, the number of inventory, a storage position, a shipping and receiving history, a turnover rate for each shelf, a picking frequency, a replenishment history, a temperature management history, a storage condition for each product, and the like of each product are acquired in real time from an RFID reader, a weight sensor, an inventory management system, a shipping and receiving gate sensor, a temperature and humidity sensor, and the like installed in each shelf and storage area in a distribution center. A past shipping and receiving history, seasonal factors, weather information, sale and event information, external demand data, a traffic condition, disaster information, and the like are also acquired from the outside. The generative AI integrally analyzes these data and predicts demand for each product with high accuracy using a prompt sentence “Generate a demand prediction for each product next week on a daily basis and a time zone basis based on a shipping and receiving history for the past three months, weather, sale information, external demand data, a traffic condition, and disaster information.” For example, a prediction is made that demand for beverages and cooling goods rapidly increases during fine weather in summer, and a shipping volume of a specific product becomes twice as normal during a sale period. Specifically, the system continuously acquires time-series data from a plurality of sensor groups. The data acquisition unit converts an acquired analog signal into digital data. The system expands the converted data as a multidimensional tensor on a memory. The system acquires meteorological data and traffic data from an external data provision server. The system encodes these external data as a natural language text and a numerical vector. The system drives a transformer-based neural network specialized for time-series prediction. The neural network includes a self-attention mechanism. The system inputs a one-dimensional array representing a daily shipping volume for the past 90 days as input data. The system inputs a numerical vector representing a temperature and a precipitation probability as input data. The system inputs a text embedding vector representing sale information as input data. The system combines these pieces of input data and maps them to a high-dimensional feature amount space. The neural network calculates a hidden correlation between respective feature amounts. The neural network outputs a demand prediction score by time zone for the future 7 days as an output. The system generates an array of floating-point numbers representing a predicted shipping volume of each product as output data. The system outputs a probability distribution representing a certainty of prediction as output data. The system outputs an attention weight matrix indicating a main factor of demand fluctuation as output data. The system transfers this prediction result to a subsequent inventory layout optimization module. The system automatically transmits a trigger signal to an ordering system when a prediction score exceeds a predetermined threshold. By this processing, the system realizes highly accurate demand prediction that does not depend on human intuition. The system mathematically minimizes a risk of overstock and out-of-stock. The system enables real-time prediction update while suppressing consumption of calculation resources. The system continuously updates a weight parameter so as to minimize a past prediction error using a backpropagation method. The system uses a mean square error as a loss function. The system searches for an optimal solution by a gradient descent method. The system is applicable to a wide range of use cases such as a logistics base of a retail business and a parts warehouse of a manufacturing business.

The generative AI automatically generates an optimal inventory layout plan for relocating products with high picking frequency to shelves near a shipping gate or a main aisle based on a demand prediction result and a current inventory layout using a prompt sentence “Generate a shelf layout plan that maximizes picking efficiency and countermeasures against overstock and out-of-stock risks based on the demand prediction result and the current inventory layout.”, and also automatically generates an action plan such as replenishment, movement, and promotion enhancement for products with an overstock or out-of-stock risk. For example, product X whose demand rapidly increases this week is relocated near a shipping gate of shelf A, product Y is relocated to an aisle side of shelf B, and specific instructions such as “Recommend promotion enhancement” when product Z is overstock and “Instruct emergency replenishment from headquarters warehouse” when product W has an out-of-stock risk are generated. Specifically, the system integrally processes a demand prediction tensor and a current three-dimensional inventory layout matrix. The system adopts a hybrid architecture combining a large language model and a reinforcement learning agent. The system inputs a numerical vector indicating a predicted demand amount of each product as input data. The system inputs three-dimensional spatial coordinate data indicating physical coordinates of a shelf in a warehouse as input data. The system inputs an attribute tensor indicating a weight and a volume of each product as input data. The system inputs these pieces of input data to a graph neural network. The graph neural network analyzes a graph structure expressing a flow line in the warehouse by nodes and edges. The system sets an objective function that minimizes a total movement distance of a picking worker. The system searches for an optimal layout state using a Markov decision process. The system outputs a three-dimensional vector indicating new storage coordinates of each product as output data. The system outputs structured data including a list of movement target products as output data. The system outputs a natural language text indicating a recommended action for an inventory risk as output data. The system transmits this output result to a control system of an automated guided robot. The system calculates a movement route of the robot based on the output coordinate data. The system issues an alert signal to a host system when a probability score of an out-of-stock risk exceeds a threshold. By this processing, the system derives an optimal solution satisfying multidimensional constraint conditions simultaneously at high speed. The system executes complex layout optimization exceeding a limit of human spatial recognition ability. The system significantly reduces a physical movement cost in the warehouse. The system sets a reduction amount of a picking completion time as a reward function of reinforcement learning. The system updates a policy function using a Q-learning algorithm. The system exhibits an extremely high technical effect in a huge fulfillment center of electronic commerce, a distribution center of pharmaceuticals, and the like.

Furthermore, the generative AI integrally analyzes a worker profile, a work task of the day, a warehouse map, a congestion status, inventory layout information, work progress, vital data, a fatigue degree and a stress level of a worker, and the like, automatically generates an optimal work assignment and a work order and route for each worker using a prompt sentence “Generate an optimal work assignment, a work order and route, and points to note based on a profile of worker ID: 001, a task of the day, a warehouse map, a congestion status, an inventory layout, work progress, and vital data.”, and creates dynamic navigation reflecting the congestion status and dangerous area information in real time. For example, picking of heavy objects and replenishment work of a large shelf are preferentially assigned to a worker having a high physical fitness level and a forklift qualification, and a shortest route “entrance→shelf A→shelf C→shipping gate” is presented, and picking of lightweight products and inspection work are assigned to a worker having anxiety about physical fitness, and a safe and efficient route “entrance→shelf B→shelf D→inspection area” is presented. The congestion status and dangerous area information are also reflected in real time, and dynamic navigation such as “Recommend a route avoiding via shelf D because the vicinity of shelf C is currently congested”, “Pause because a forklift is passing”, and “Guide another route because an obstacle is detected near an emergency exit” is also possible. Specifically, the system links a dynamic routing algorithm and a large language model. The system inputs a multidimensional vector indicating a skill level and a past work history of each worker as input data. The system inputs a time-series array of a heart rate and a body surface temperature acquired from a smart watch as input data. The system inputs a heat map image tensor indicating a real-time congestion degree in a warehouse as input data. The system inputs these pieces of input data to a multimodal neural network. The neural network has a structure combining a convolutional layer and a long short-term memory layer. The system quantifies a fatigue degree of a worker as a continuous value score from 0 to 1. The system executes a heuristic search extending Dijkstra's algorithm or an A-star algorithm. The system outputs an array of task identifiers assigned to each worker as output data. The system outputs a route vector including a coordinate list of nodes to be passed through as output data. The system outputs a natural language text including a specific instruction to a worker as output data. The system transmits this output result to a mobile terminal of each worker in real time. The system immediately recalculates an alternative route when a congestion score on a route exceeds a threshold. By this processing, the system realizes flexible task distribution impossible with static rule-based assignment. The system simultaneously achieves ensuring safety of a worker and maximizing an overall throughput. The system efficiently uses computer resources and completes route calculation for hundreds of workers in milliseconds. The system optimizes a model so as to maximize a success reward of route guidance using reinforcement learning. The system is applicable to all use cases requiring dynamic personnel assignment, such as an assembly line of a manufacturing plant and staff assignment of a large-scale event.

AR navigation and work instructions with multilingual support created by the generative AI are distributed in real time to AR glasses or a smartphone worn by a worker, and instructions such as “Please proceed to shelf A and pick product X. Next, please move to shelf C.” and “Since this product is a heavy object, please transport it with a forklift.” are displayed in Japanese, English, Chinese, and the like. Progress and vital data of the worker are also monitored in real time, and an alert is transmitted to an administrator if there is an abnormality. For example, notifications such as “Physical condition abnormality of worker ID: 001 detected, break recommended” and “Progress delay of worker ID: 002, additional support requested” are automatically transmitted to a management terminal. Specifically, the system adopts an edge-cloud cooperative architecture integrating an augmented reality rendering engine and a natural language processing model. The system inputs a three-dimensional coordinate vector indicating a current position of a worker as input data. The system inputs an RGB image tensor indicating a visual field video of a worker as input data. The system inputs a categorical variable indicating a native language setting of a worker as input data. The system inputs these pieces of input data to a real-time translation model and a spatial mapping module. The system simultaneously executes self-position estimation and environmental map creation. The system outputs three-dimensional rendering data of a virtual object to be superimposed and displayed on a visual field video as output data. The system outputs a translated text character string as output data. The system outputs an abnormality score indicating a probability of a vital abnormality as output data. The system transmits this output result to a display control unit of a wearable device. The system transmits an emergency interrupt signal to a dashboard of an administrator when an abnormality score exceeds a safety threshold. By this processing, the system realizes intuitive work support beyond a language barrier. The system physically reduces a cognitive load of a worker. The system executes heavy image processing on a cloud side and executes lightweight drawing processing on an edge side in order to supplement limited calculation resources of a wearable device. The system applies a data compression algorithm for minimizing a communication delay. The system uses an autoencoder as an abnormality detection model, and determines an abnormality from a reconstruction error of normal vital data. The system is widely applicable to use cases requiring advanced information presentation and safety monitoring, such as surgery support in a medical field and safety management of multinational workers in a construction site.

As described above, the system of the present invention realizes overall optimization and advanced automation of a distribution center site using a generative AI, such as real-time attribute analysis and health management for each worker, dynamic inventory layout optimization based on demand prediction, individually optimized work instruction and flow line navigation according to worker characteristics and site conditions, site support by multilingual support and AR support, abnormality detection and immediate alert, and flexible operation and instruction generation by an administrator. Specifically, the present system functions as a central control orchestrator that integrates a plurality of subsystems. The present system aggregates multidimensional inference results output from each module into a shared memory space. The present system inputs a status code array from each subsystem as input data. The present system inputs a resource usage vector indicating a processing load of the entire system as input data. The present system inputs a numerical tensor indicating a performance index of the entire distribution center as input data. The present system inputs these pieces of input data to a meta-learning model. The meta-learning model dynamically adjusts weighting of each subsystem. The present system outputs a floating-point array indicating a resource allocation ratio to each edge device as output data. The present system outputs a comprehensive evaluation score indicating a degree of optimization of the entire system as output data. The present system outputs a control matrix defining a processing priority of a next cycle as output data. The present system forms a feedback loop of the entire system using this output result. When the comprehensive evaluation score decreases, the present system automatically activates a re-learning process of each model in a background. By this processing, the present system realizes a self-evolving computer system that autonomously improves operational efficiency of the entire facility beyond mere automation of individual tasks. The present system eliminates manual intervention by a human to the utmost limit. The present system adopts a non-conventional calculation method that simultaneously optimizes complexly intertwined variables in a high-dimensional space. The present system defines a global loss function integrating loss functions of respective neural networks, and minimizes an error of the entire system. The present system is extremely useful in a control use case of a complex network in which a plurality of autonomous agents cooperatively operate, such as infrastructure management of a smart city and a large-scale traffic control system.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

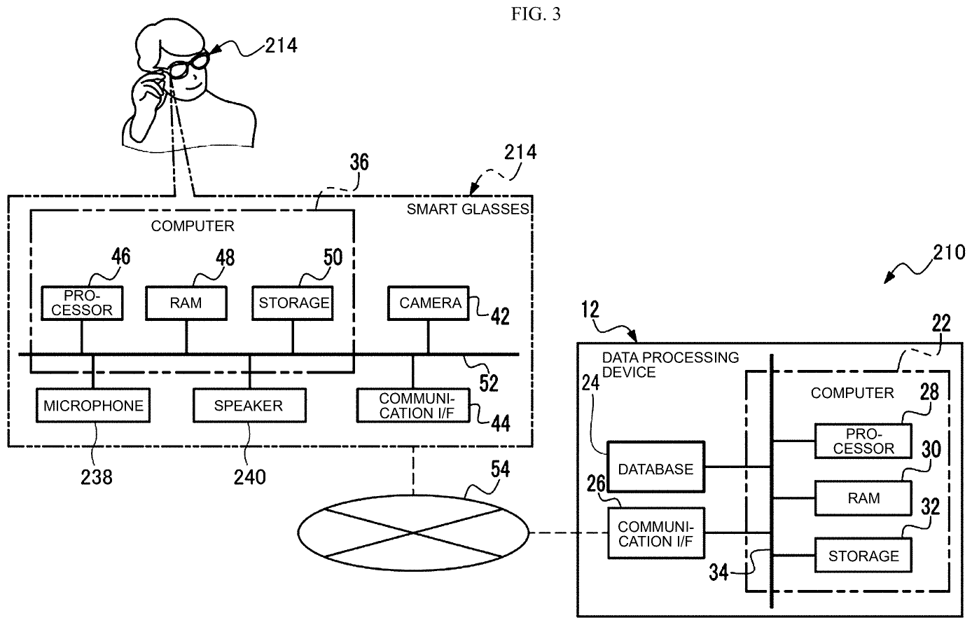

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

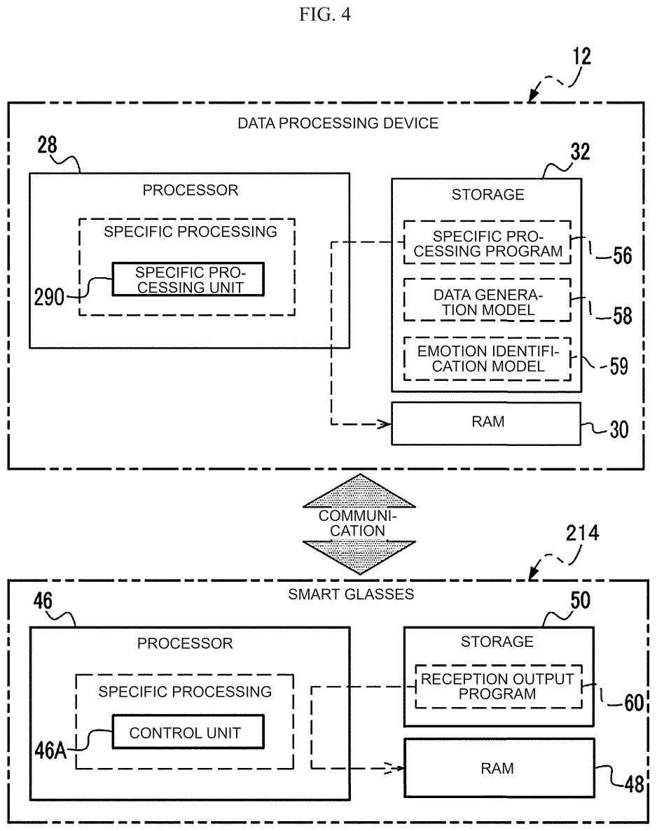

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### EXAMPLE 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

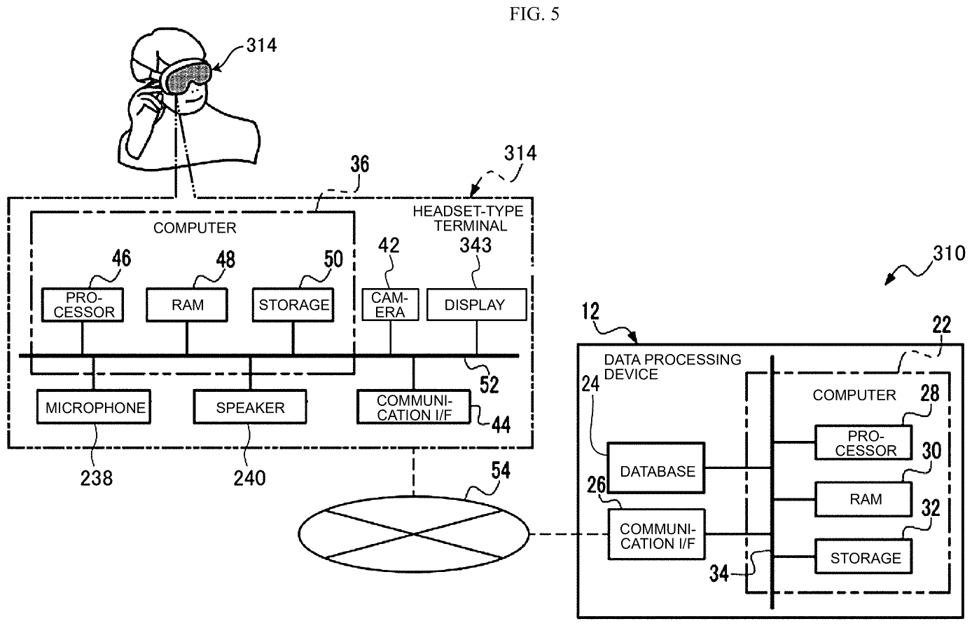

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

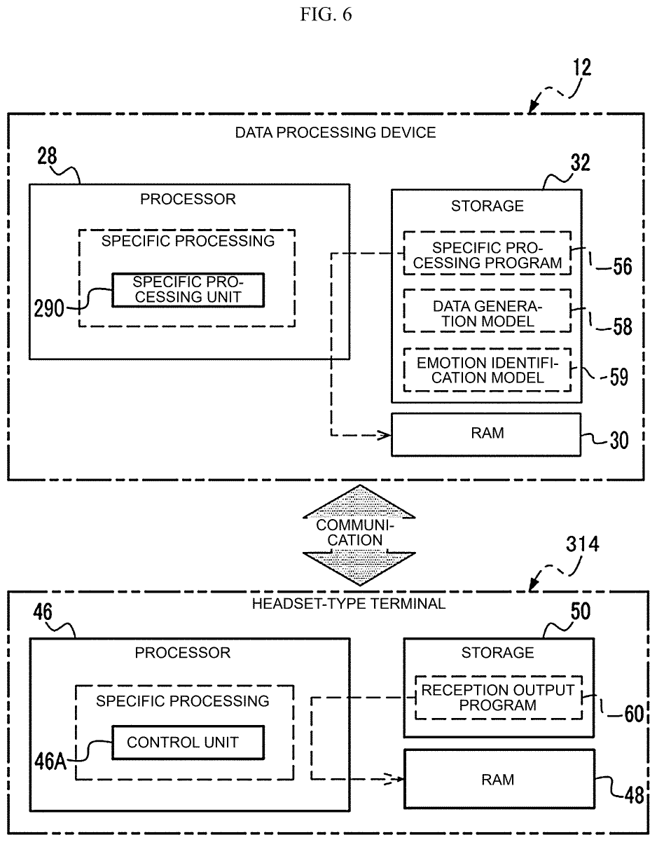

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

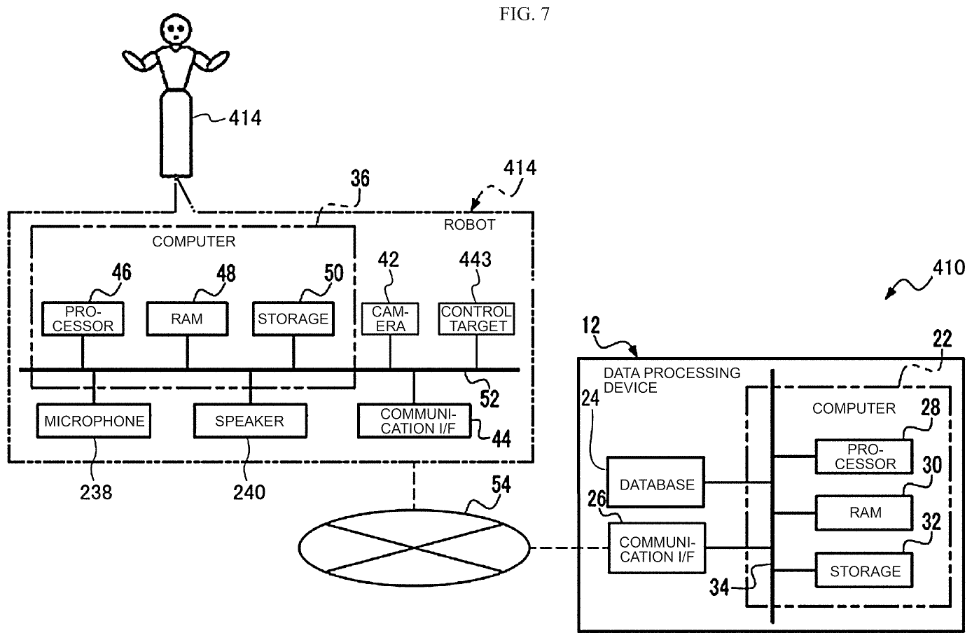

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

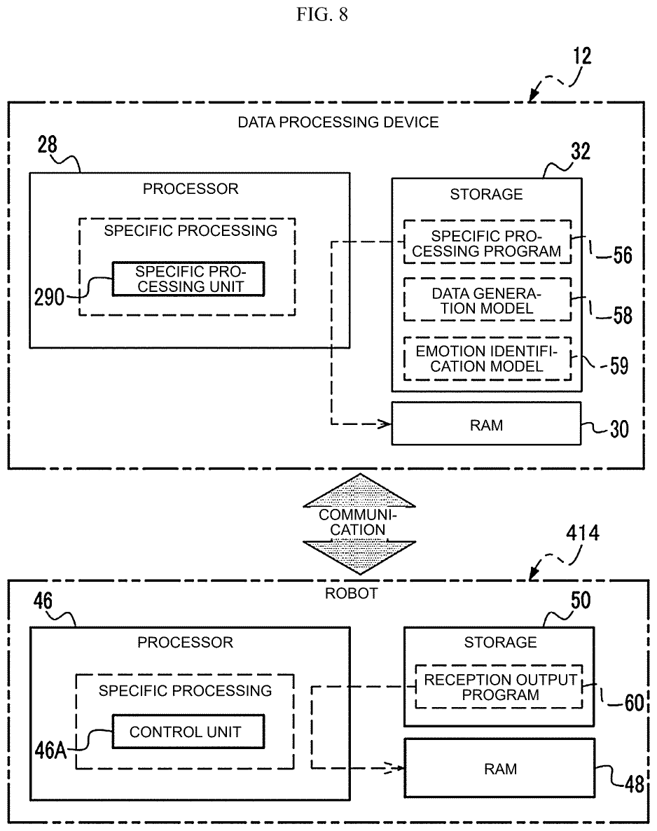

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

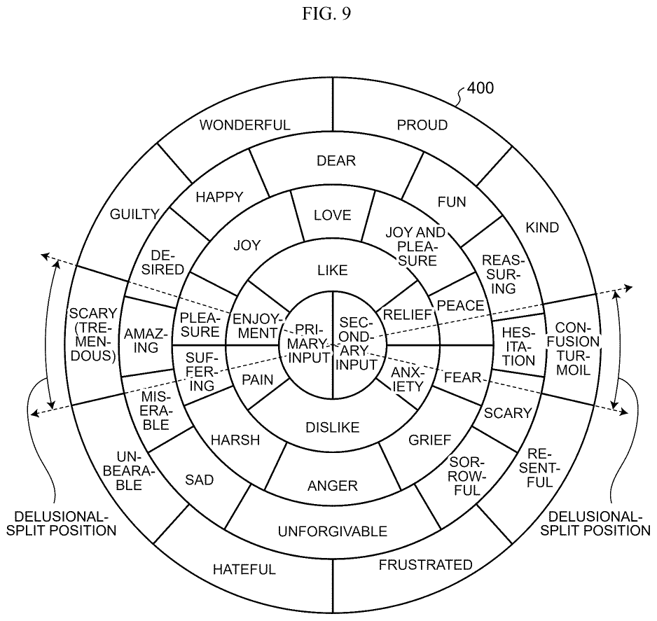

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

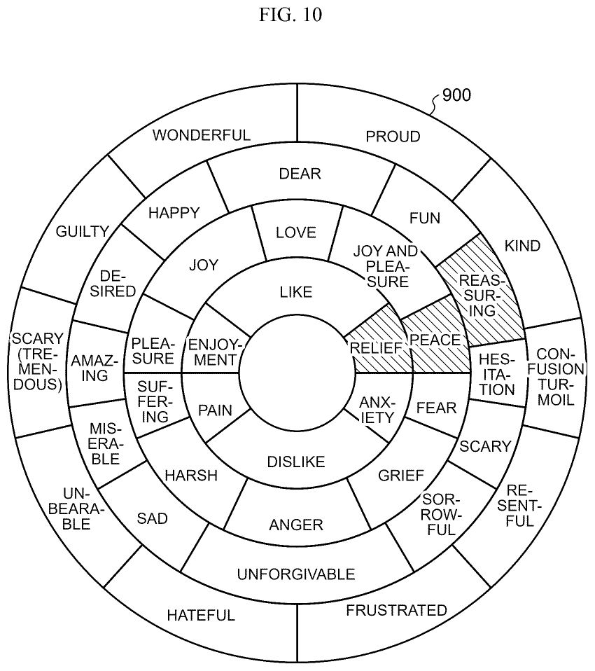

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A distribution center operation system comprising: a worker attribute analysis unit; an inventory layout optimization unit; and a flow line navigation unit, wherein the worker attribute analysis unit analyzes image data, motion data, biological information, work history, qualification information, and the like of a worker acquired from a camera, a vital sensor, a wearable device, and the like by a generative AI, and generates a detailed profile such as years of experience, qualifications, physical fitness level, work speed, past work tendency, proficient work area, and health condition of the day of each worker in real time; the inventory layout optimization unit integrally analyzes inventory data, past shipping and receiving history, seasonal factors, weather, sale and event information, external demand data, and the like acquired from an RFID reader, a weight sensor, an inventory management system, and the like by the generative AI, and automatically generates an optimal inventory layout plan for relocating products with high picking frequency to shelves near a shipping gate or a main aisle based on demand prediction; and the flow line navigation unit analyzes a worker profile, a work task of the day, a warehouse map, a congestion status, inventory layout information, and the like by the generative AI, automatically generates an optimal work order and route for each worker, and further distributes real-time navigation information including multilingual support and visual assistance to a terminal such as AR glasses or a smartphone.

### (Supplementary Note 2)

The system according to Supplementary Note 1, wherein the worker attribute analysis unit acquires a face image, a full-body image, a motion video, vital data, a work history, qualification information, a past work tendency, and the like of a worker from a camera, a wearable sensor, and the like, generates a multidimensional profile such as years of experience, qualifications, physical fitness level, work speed, health condition, and proficient work area in real time by a generative AI, and further automatically generates an optimal work assignment and a break instruction for each worker based on the profile and notifies a management terminal of the optimal work assignment and the break instruction.

### (Supplementary Note 3)

The system according to Supplementary Note 1, wherein the flow line navigation unit analyzes a worker profile, a work task of the day, a warehouse map, a congestion status, inventory layout information, work progress, vital data, and the like by a generative AI, automatically generates an optimal work order and route for each worker, distributes real-time navigation information including multilingual support and visual assistance to a terminal such as AR glasses or a smartphone, monitors progress and a health condition of the worker, and automatically transmits an alert to an administrator terminal in an event of an abnormality.

What is claimed is:

1. A system comprising:
circuitry configured to:
receive, via a communication interface coupled to a packet-switched network, sensor data from IoT sensor devices distributed across a processing facility and personnel position tracking data from location sensor devices, and store the received data in a storage device;
apply a convolutional neural network to image tensor data from imaging devices to extract entity attribute feature vectors and movement trajectory data, and apply an inventory state estimation model to sensor data from shelf-mounted IoT sensor devices to generate a current inventory state record;
apply a generative neural network model to the movement trajectory data, the current inventory state record, and historical throughput data to generate a layout optimization data record comprising recommended position assignments and movement path configurations;
apply a demand prediction model to historical transaction records and external context data to generate a demand forecast data record, and generate a replenishment schedule data record by applying the generative neural network model to the demand forecast data record and the current inventory state record; and
transmit the layout optimization data record, the replenishment schedule data record, and navigation instruction data derived from the movement trajectory data to terminal devices via the communication interface.

2. The system according to claim 1, wherein the circuitry is configured to receive image tensor data from imaging devices at edge computing nodes, apply a lightweight convolutional neural network at each edge computing node to extract compact spatial feature vectors, and transmit the compact spatial feature vectors to a cloud computing node via the communication interface for full model inference.

3. The system according to claim 2, wherein the circuitry is configured to apply a human pose estimation model at the cloud computing node to skeletal joint coordinate sequences extracted from the compact spatial feature vectors, compute movement parameter vectors comprising velocity, heading direction, and trajectory curvature, and generate movement trajectory data for each tracked entity identifier.

4. The system according to claim 1, wherein the circuitry is configured to receive weight sensor values, optical fill-level sensor values, and RFID reader scan records from shelf-mounted IoT sensor devices via the communication interface, fuse the received sensor values to compute an occupancy estimate for each storage location identifier, and update the current inventory state record with the computed occupancy estimates.

5. The system according to claim 4, wherein the circuitry is configured to apply a predictive inventory model to the current inventory state record and the demand forecast data record to compute a projected stockout probability for each item identifier, and generate a priority-ranked replenishment item list sorted in descending order of projected stockout probability.

6. The system according to claim 1, wherein the circuitry is configured to apply a graph neural network to a facility layout graph comprising storage location nodes and movement path edges, execute message passing operations to propagate throughput efficiency scores between adjacent nodes, and compute an optimal storage position assignment for each item category by maximizing aggregate throughput efficiency.

7. The system according to claim 6, wherein the circuitry is configured to apply the layout optimization data record to generate reconfiguration instruction data specifying item category movements from current position assignments to recommended position assignments, and transmit the reconfiguration instruction data to terminal devices associated with operations personnel user identifiers.

8. The system according to claim 1, wherein the circuitry is configured to apply a route optimization model to the movement trajectory data and a task assignment record to generate navigation instruction data comprising a sequence of waypoint coordinates for each tracked entity identifier, and transmit the navigation instruction data to terminal devices associated with the corresponding entity identifiers via the communication interface.

9. The system according to claim 8, wherein the circuitry is configured to display the navigation instruction data on augmented reality display devices worn by personnel at the facility by overlaying waypoint coordinate markers on a real-time camera view, and update the displayed navigation instructions in real time as movement trajectory data is updated.

10. The system according to claim 1, wherein the circuitry is configured to generate a demand forecast data record by applying a transformer-based time-series model to historical transaction records and external context data comprising weather condition values and scheduled event indicators, and compute prediction confidence intervals by Monte Carlo dropout sampling.

11. The system according to claim 1, wherein the circuitry is configured to apply a workforce allocation optimization model to the current personnel position tracking data and the replenishment schedule data record to generate a personnel task assignment data record minimizing total task completion time, and transmit the personnel task assignment data record to terminal devices associated with operations management user identifiers.

12. The system according to claim 1, wherein the circuitry is configured to apply a quality deviation detection model to image tensor data from inspection imaging devices by applying a convolutional neural network to compute a defect probability score for each inspected item, and generate a quality alert data record when a defect probability score exceeds a quality threshold parameter.

13. The system according to claim 1, wherein the circuitry is configured to generate a unified operational dashboard data record from the layout optimization data record, replenishment schedule data record, demand forecast data record, and personnel task assignment data record, and transmit the dashboard data record to terminal devices associated with management user identifiers.

14. The system according to claim 1, wherein the circuitry is configured to update the generative neural network model by generating training pairs from historical layout optimization data records and corresponding validated throughput outcome records, and fine-tune the model to improve layout recommendation accuracy.

15. The system according to claim 1, wherein the circuitry is configured to encrypt data transmissions between IoT sensor devices, edge computing nodes, and the cloud computing node using a transport layer security protocol, and authenticate each IoT sensor device using a device certificate prior to accepting sensor data streams.

16. The system according to claim 1, wherein the circuitry is configured to apply a worker safety monitoring model to the personnel position tracking data and equipment operation state data to detect proximity risk events, generate a safety alert when a proximity risk event exceeds a safety threshold parameter, and transmit the safety alert to terminal devices associated with safety management user identifiers.

17. The system according to claim 1, wherein the IoT sensor devices and imaging devices are distributed across a logistics processing facility, the entity attribute feature vectors represent tracked personnel and equipment within the facility, and the layout optimization data record specifies storage position assignments optimized for throughput efficiency.

18. A system comprising:
circuitry configured to:
receive, via a communication interface coupled to a packet-switched network, sensor data from IoT shelf sensors and image data from imaging devices in a processing facility;
apply a convolutional neural network to extract spatial feature vectors, a pose estimation model to generate movement trajectory data, and an inventory state estimation model to generate a current inventory state record;
apply a graph neural network to a facility layout graph to compute optimal storage position assignments, and apply a demand prediction model to generate a replenishment schedule data record;
apply a route optimization model to generate navigation instruction data, and display instructions on augmented reality devices; and
transmit layout optimization data records, replenishment schedules, and navigation data to terminal devices via the communication interface.

19. The system according to claim 18, wherein the circuitry is configured to apply a workforce allocation optimization model to generate personnel task assignment data records minimizing total task completion time, apply a quality deviation detection model to generate defect probability scores, and generate a unified operational dashboard from all optimization data records for transmission to management terminal devices.

20. A method comprising:
receiving, via a communication interface coupled to a packet-switched network, sensor data streams from IoT sensor devices and personnel position tracking data from location sensors in a processing facility, and storing the data in a storage device;
applying a convolutional neural network to extract entity attribute feature vectors, and an inventory state estimation model to generate a current inventory state record;
applying a generative neural network model to generate a layout optimization data record and a replenishment schedule data record; and
transmitting the layout optimization data record, the replenishment schedule data record, and navigation instruction data to terminal devices via the communication interface.
